(19) United States
(12) Patent Application Publication
(10) Pub. No.: US 2016/0267547 A1
(43) Pub. Date: Sep. 15, 2016

(54) INFORMATION PROVIDING DEVICE AND METHOD THEREFOR, AND NON-TRANSITORY COMPUTER READABLE MEDIUM

(71) Applicant: Kabushiki Kaisha Toshiba, Minato-ku (JP)

(72) Inventors: Shinya UMENO, Kawasaki (JP); Ryusei Shingaki, Ota (JP)

(73) Assignee: Kabushiki Kaisha Toshiba, Minato-ku (JP)

(21) Appl. No.: 15/139,576

(22) Filed: Apr. 27, 2016

Related U.S. Application Data
(63) Continuation of application No. PCT/JP2014/074213, filed on Sep. 12, 2014.

(30) Foreign Application Priority Data
Oct. 30, 2013 (JP) 2013-225935

(51) Int. Cl. G06Q 30/02; H04L 29/08

(52) U.S. Cl. CPC G06Q 30/0269; H04L 67/22; H04L 67/306; G06Q 30/0201

(57) ABSTRACT

According to one embodiment, an information providing device includes; an evaluation value calculator, a profile setter and an information transmission processing unit. The evaluation value calculator calculate an evaluation value on each of a plurality of time periods based on behavior history data which indicates a history of days and times of occurrence of a specific behavior taken by a user, the evaluation value indicating likelihood of the specific behavior being taken by the user. The profile setter sets a profile on the user based on the evaluation values of the time periods, the profile indicating a tendency of time periods at which the specific behavior is taken by the user. The information transmission processing unit determines offer information for providing to the user according to the profile of the user and transmits the offer information to an output device related to the user.

### CROSS REFERENCE TO RELATED APPLICATIONS

This application is a Continuation of International Application No. PCT/JP2014/074213, filed on Sep. 12, 2014, the entire contents of which is hereby incorporated by reference.

### FIELD

Embodiments described herein relate an information providing device, a method therefore and non-transitory computer readable medium.

### BACKGROUND

In the related art, a technology is proposed which in an information providing service directed to a user such as an individual or a family user, estimates a current behavior of the user (for example, in business, exercise, cooking or travel) and provides information based on the estimated behavior. Also, there is proposed another technology which provides information based on a frequency of occurrence of behavior of a user (for example, a number of riding on a train for a week, a number of browsing a WEB specific page, a number of clicking of a specific link).

Moreover, there is a method which extracts a plurality of frequent behavior patterns from a behavior history of daily life and provides information based on the frequent behavior patterns. The method analyzes the extracted frequent behavior patterns by way of means such as clustering and extracts a finite number of typical life patterns according to the result of the analysis. The method then provides information depending on whether the user's lifestyle is near which of the typical life patterns.

However, the above-stated technology and methods necessarily do not provide appropriate information to the user.

### BRIEF DESCRIPTION OF THE DRAWINGS

FIG. 1 is an overall block diagram of an information providing system according to a first embodiment.

FIG. 2 is a flow chart of an operation of the information providing server according to the first embodiment.

FIG. 3 shows an example of behavior history data generated by the behavior estimator according to first the embodiment.

FIG. 4A shows a weekday at home probability in a tabular form according the first embodiment.

FIG. 4B shows a weekday at home probability in graph form according to the first embodiment.

FIG. 5A shows a weekday at home probability in a tabular form the first embodiment.

FIG. 5B shows a weekday at home probability in graph form according to the first embodiment.

FIG. 6 shows data examples stored in a profile candidate storage according to the first embodiment.

FIG. 7 shows an example of a condition determination result according to the first embodiment.

FIG. 8 shows an example another data stored in the profile candidate storage according to the first embodiment.

FIG. 9 shows an example of a table in which priorities are set for profile candidates according to the first embodiment.

FIG. 10 shows an example of a profile set for each user according to the first embodiment.

FIG. 11 shows an example of an attribute table according to the first embodiment.

FIG. 12 shows an example of an information attribute set for each user according to the first embodiment.

FIG. 13 shows an example of an information providing table stored in an offer information storage according to the first embodiment.

FIG. 14 shows hardware configuration according to the first embodiment.

FIG. 15 shows a variation of the information providing system in FIG. 1.

FIG. 16 A shows reference data in a tabular form according to a second embodiment.

FIG. 16 B shows reference data in graph form according to a second embodiment.

FIG. 17 shows kitchen consumed power energy according to a third embodiment.

FIG. 18 shows an example of an estimate result of existence or non-existence of cooking according to the third embodiment.

FIG. 19 shows an example of profile candidate and selection condition concerning the cooking according to the third embodiment.

FIG. 20 shows an example of a profile candidate and selection condition concerning laundry according to the third embodiment.

FIG. 21 shows a determination result example of a selection condition of each profile candidate according to the third embodiment.

FIG. 22 shows examples of a at home profile, a cooking profile and a laundry profile set for each user according to the third embodiment.

FIG. 23 shows an example of an attribute table stored in attribute storage according to the third embodiment.

FIG. 24 shows an example of an attribute setting table stored in an attribute setting storage according to the third embodiment.

FIG. 25 is a block diagram of the information providing system according to a fourth embodiment.

FIG. 26 shows an example of an information table stored in an offer information storage according to the fourth embodiment.

FIG. 27 is a block diagram of an information providing system according to a fifth embodiment.

FIG. 28 is a block diagram of an information providing system according to a sixth embodiment.

### DETAILED DESCRIPTION

According to one embodiment, an information providing device comprising a computer including at least one processor, includes; an evaluation value calculator, a profile setter and an information transmission processing unit. The evaluation value calculator calculate an evaluation value on each of a plurality of time periods based on behavior history data which indicates a history of days and times of occurrence of a specific behavior taken by a user, the evaluation value indicating likelihood of the specific behavior being taken by the user. The profile setter sets a profile on the user based on the evaluation values of the time periods, the profile indicating a tendency of time periods at which the specific behavior is taken by the user. The information transmission processing unit determines offer information for providing to the user according to the profile of the user and transmits the offer information to an output device related to the user.

Hereinafter, embodiments of the present invention will be described with reference to the drawings.

### First Embodiment

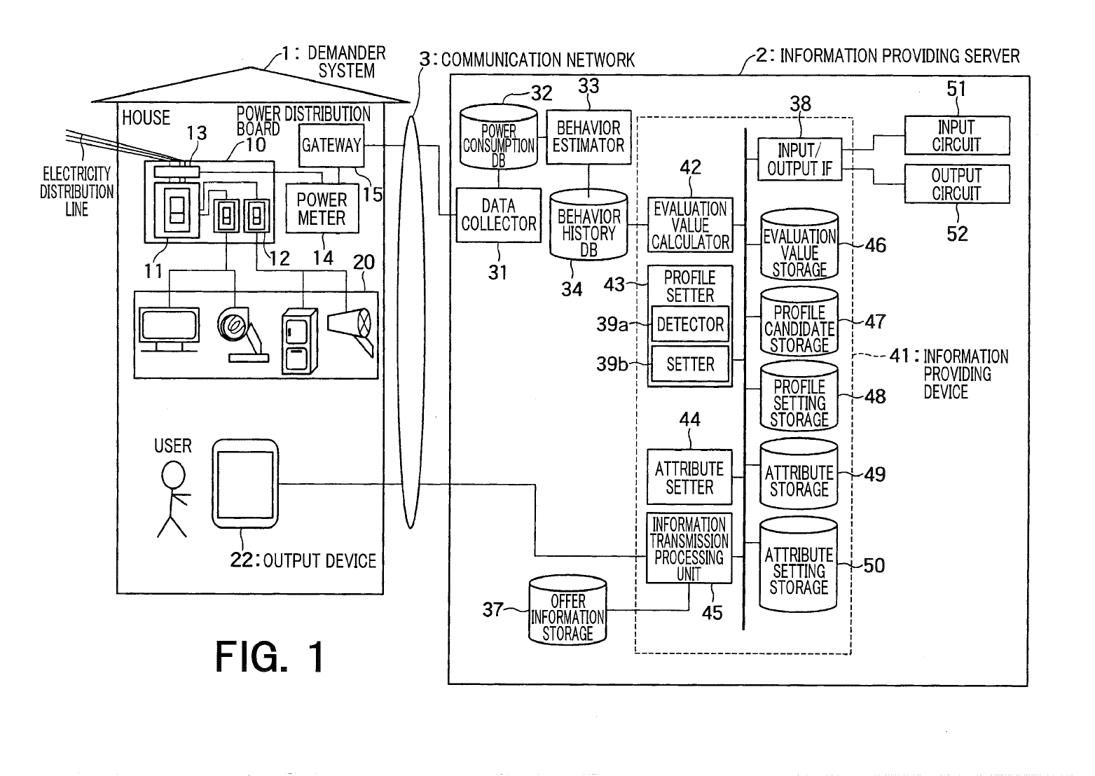

FIG. 1 is an overall block diagram of an information providing system according to a first embodiment.

In FIG. 1, the information providing system includes a demander system 1 provided in a demander, an information providing server 2, and a communication network 3 connecting the system 1 and the server 2. The demander corresponds to a building such as a house, or residential building and in the present embodiment, the house is assumed. In the house, an individual user or a family user which is ingathering of individuals (below, unified to the user) is resident. In the figure, although only one demander is depicted, a plurality of demander may actually be present. In the demander system 1, power consumption is measured in the house, measured power consumption data is transmitted to the information providing server 2. The information providing server 2 collects, from the demander system 1, power consumption data. The information providing server 2 estimates, based on a plurality of day's power consumption data, whether the user performs a specific behavior among a plurality of types of behaviors (for example, the specific behavior include “at home” or “cooking” etc.) at a predetermined time interval. Thereby, the server 2 acquires behavior history data which indicates a history of day and time of occurrence of a specific behavior taken by the user. The information providing server 2 calculates an evaluation value for each time period based on the acquired behavior history data, for each a plurality of time period (for example, for each time period at 30 minutes interval from 8:00 to 17:00). The evaluation value indicates magnitude of probability which the user takes the specific behavior (i.e., likelihood). The information providing server 2 set a profile on the user based on the evaluation value of each time period where the profile indicates tendency of time periods in which the user takes the specific behavior (for example, there is the user's tendency to be at home in morning and daytime, or the user's tendency to be going out in morning and daytime). The information providing server 2 determines information for providing to the user (it may be called offer information) based on the profile set for the user. The information providing server 2 transmits the offer information as determined, to an output device 22 of the user via a network. In the present embodiment, whether the user took the specific behavior is estimated based on power consumption data to acquire the behavior history data. Alternatively, via user questionnaire etc., actual value is acquire of whether the user took the specific behavior and based on the actual value, the behavior history data may be acquired. Alternatively, behavior model for predicting day and time in future the user takes the specific behavior may be provided. Then, based on the day and time predicted from the behavior model, the behavior history data may be acquired. In these manners, as the behavior history data used in processing which is explained below, behavior history data based on the actual value or the predicted value may be used instead of the behavior history data based on the behavior estimation.

Below, the information providing system in FIG. 1 is explained in detail.

The demander system 1 includes a power distribution board 10, a power meter 14, a gateway 15 which collects power consumption data measured by a power meter 14 and transmits them to the information providing server 2 and an output device 22 which outputs (displays etc.) information transmitted from the information providing server 2.

For the demander, the electricity distribution line is drawn from an external into the power distribution board 10. The electricity distribution line is connected to a trunk power breaker 11 which is a breaker for overall control in the demander. The trunk power breaker 11 is supplied with power from the electricity distribution line. Under the trunk power breaker 11, a plurality of sub-breakers 12 are connected via the electricity distribution line. The sub-breakers 12 are connected to the plurality of electric appliances 20. The electric appliance 20 may be an appliance which consumes power. In the example shown in the figure, a television, an illumination, a refrigerator and a dryer are present. As another example, an air-conditioner, a laundry machine, a vacuum cleaner, an iron, an instantaneous water heater, IH-cooking device, an EV (Electric Vehicle) etc. may be present. The sub-breaker 12 and the electric appliance 20 are generally connected via a receptacle outlet (not shown in the figure).

On the electricity distribution line connected to the trunk power breaker 11, a current sensor 13 is provided which measures an instantaneous value of current. The power meter 14 uses the sensing value obtained from the current sensor 13 and periodically measures an instantaneous value or an instantaneous power of consumed power in the demander. This measure is executed, for example, at one minute time interval. But, the one minute is one example, and a time interval to be used may be shorter or longer than the one minute. The measured value may be an overall power value that the sub-breakers are collected, or power value at a sub-breaker basis. A smart tap may be provided on each electric appliance and a power value may be measured on an electric appliance basis. The power meter 14 sends the measured value of power wiredly or wirelessly, to the gateway 15, which corresponds to the power consumption data. The gateway 15 temporarily holds the power consumption data as received, and transmits the power consumption data via the communication network 3 to the information providing server 2 wiredly or wirelessly. Although, in this example, the power meter 14 measures the instantaneous power, the power meter 14 may measure, as another example, an average power per one minute, or consumption power energy per one minute, and acquire it as the power consumption data.

The output device 22 receives information transmitted from the information providing server 2 via the communication network 3 and outputs the received information. Examples of the output device 22 includes a tablet display device placed on a wall etc. in the house, a personal computer (PC), a mobile terminal (e.g., a mobile phone or a smart phone), a television (TV). The information provided from the information providing server 2 includes image data, text data, voice data, or any combination thereof. When the information received from the information providing server 2 is the image data or text data, the output device 22 displays the image or the text on the screen, and when the information is the voice data, the output device 22 outputs voice from a speaker.

The information providing server 2 includes a data collector 31, a power consumption database (DB) 32, a behavior estimator 33, a behavior history DB 34, an information providing device 41, an input circuit 51, an output circuit 52, an offer information storage 37.

The data collector 31 collects the power consumption data measured in the house from the demander system 1 via the communication network 3. As a method of collecting, the data collector 31 may collect the power consumption data at a timing determined by the data collector 31 according to the gateway 15 in the demander system 1. Alternatively, the gateway 15 may determine a timing of transmitting the power consumption data and connect to the data collector 31 at the determined timing to transmit the power consumption data to the data collector 31. A method other than that described herein may be used to collect the power consumption data.

The power consumption DB 32 is connected to the data collector 31 and stores the power consumption data collected by the data collector 31 therein. In a case that the power consumption data is collected from a plurality of user, the power consumption DB32 stores power consumption data for each user.

The behavior estimator 33 is connected to the power consumption DB 32, uses the power consumption data in the power consumption DB 32 and performs behavior estimation which estimates whether a user to be targeted (which is called a target user below) took a predetermined specific behavior. The specific behavior is a predetermined behavior among various behaviors which are taken by the user in daily life. The behavior estimation is performed for each time period at a predetermined time interval such as 30 minutes, 1 minute or 30 seconds, for each of a plurality of days. Thereby, the behavior estimator 33 obtains the behavior history data which indicates a history of day and time of occurrence of the specific behavior taken by the user. The behavior estimator 33 stores the behavior history data in the behavior history DB 34. The behavior history DB 34 is connected to the behavior estimator 33. The behavior estimation may be performed for all of 24 hours a day or for a specific time period (for example, 8:00 to 24:00) a day.

The specific behavior may be arbitrarily defined as long as existence or non-existence of a behavior can be estimated. In the present embodiment, “at home” (the user is resident in the house) is interested as one example. In this case, the behavior estimator 33 estimate existence or non-existence of at home as the specific behavior of the target user. The behavior estimator 33 set a behavior label indicating, a result of estimation for a corresponding time period for which the estimation is performed. In a case that the target user is estimated to be at home, a label of “at home” is set and in a case that the target user is estimated to be not at home, a label of “go out” is set. As a method of estimating existence or non-existence of at home, for example, the following method may be used that a threshold is set and when an overall power consumption value (instantaneous power) in the house is larger than the threshold, “at home” is determined and otherwise, “go out” is determined. For example, when the power consumption data indicates the instantaneous power per one minute and in a certain time period, the instantaneous power never exceed the threshold, the “go out” is determined. When the instantaneous power exceed the threshold at least one time, at home is determined. The estimate example as described here is one example, and any method can be used as long as the behavior estimation can be performed based on the power consumption data. In the present example, although the specific behavior is “at home” and existence or non-existence of at home is estimated, the specific behavior may be “go out” and existence or non-existence of going out may be estimated. Even in this way, the same results can be obtained.

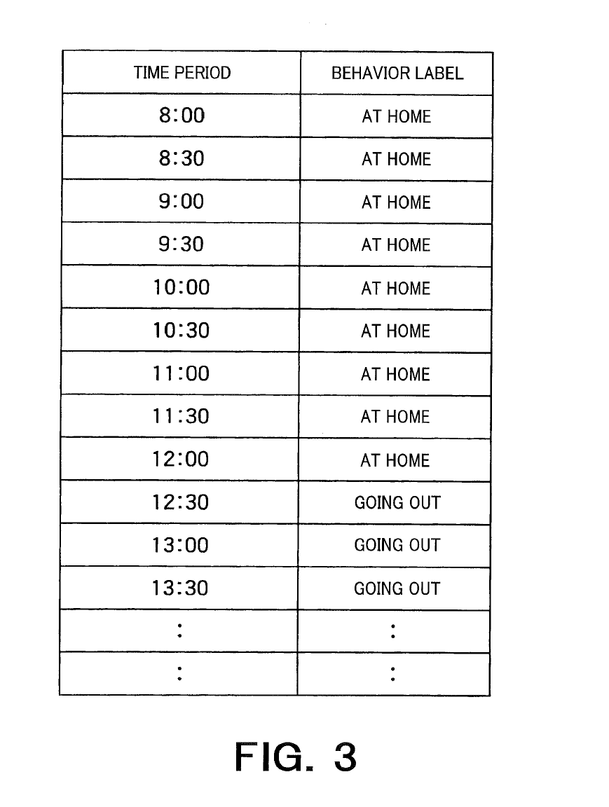

FIG. 3 shows an example of behavior history data generated by the behavior estimator 33.

In this example, a day is divided at 30 minutes unit. For each time period, whether a target user is at home or not at home (go out) is indicated at each row. For example, since on Oct. 1, 2013, 8:00 to 8:30, the target user is at home, the behavior label of “at home” is given. On the other hand, since on Oct. 1, 2013, 12:30 to 13:00, the target user is not at home, the behavior label of “go out” is given. In a case that the target user is a family, “at home” means that at least one person is at home and “go out” means that all persons are not at home. Although in this example, a day is divided at 30 minutes unit, a unit for dividing may be determined such as 10 seconds unit, 1 minute unit, or 1 hour unit. In FIG. 3, a time period of a part of a day is presented, but data for a plurality of days are actually stored.

The information providing device 41 calculates, by using the behavior history data in the behavior history DB 34, an evaluation value for each of a plurality of time period, indicating magnitude of probability (likelihood) at which the target user takes the specific behavior. Then, the information providing device 41 calculates a tendency of time periods at which the target user takes the specific behavior based on the evaluation value of each time period, and sets a profile indicating the calculated tendency of the time periods for the target user. The information providing device 41 determines information to be provided to the target user (offer information) according to the set profile. The information providing server 2 obtains the offer information from the offer information storage 37 and transmits it to the output device 22 of the target user.

The information providing device 41 includes an evaluation value calculator 42, a profile setter 43, an attribute setter 44, an information transmission processing unit 45, an input/output IF 38, and plural storages, which are connected via a bus. The storages include an evaluation value storage 46, a profile candidate storage 47, a profile setting storage 48, an attribute storage 49, an attribute setting storage 50. The information transmission processing unit 45 is connected to the communication network 3. In the figure, the information transmission processing unit 45 and the data collector 31 are depicted to be connected to the communication network 3 separately: however, the information transmission processing unit and the data collector 31 may be connected to the communication network 3 at a same network interface.

The information providing device 41 are connected to the input circuit 51 and output circuit 52 at the input/output IF 38. The input circuit 51 is a device for inputting instructions or orders such as a keyboard, a pointing device or a touch panel. The output circuit 52 is a display for displaying data read from the information providing device 41 according to an instruction from the input circuit 51. The display is, for example, a liquid crystal display, a CRT device, a plasma display, or an electronic paper etc.

The evaluation value calculator 42 is connected to the behavior history DB 34, and based on a predetermined time period of the behavior history data in the behavior history DB 34, evaluates an evaluation value for evaluating magnitude of possibility (likelihood) at which the target user takes the specific behavior at each time period. The evaluation value calculator 42 stores the calculated evaluation value of each time period in the evaluation value storage 46. Each time period for which the evaluation value is calculated coincides with each time period for which the behavior estimation was performed. Alternatively, each time period for which the evaluation value is calculated may be different from each time period for which the behavior estimation was performed. In this case, a length of each time period for which the evaluation value is calculated may be different from a length of each time period for which the behavior estimation was performed. For example, the behavior estimation may be performed for each time period at a time interval of 30 minutes, and the evaluation value may be calculated for each time period at a time interval of an hour. In the present embodiment, it is assumed that each time period for which the evaluation value is calculated coincides with each time period for which the behavior estimation was performed.

Below, a calculation example of the evaluation value for each time period is described. As one example, a ratio of a number of labels indicating the specific behavior being taken (i.e., labels with existence of the specific behavior) to a total number of labels given to the relevant time period is calculated. Specifically, a ratio of a number of dates of the specific behavior taken by the user at the relevant time period to a number of dates of behavior history data used for calculating the evaluation value is calculated. The thus calculated evaluation value is below called a behavior probability. It can be said that higher the behavior probability is, higher a possibility of the specific behavior taken by the user is.

It is also possible to set a weight on data of each day in the behavior history data. For example, a higher weight is set on data of temporally more recent day. As one example, when the behavior history data is used for 15 days, a weight of 0.9 is set for data of first date, a weight of 1.1 is set for data of fifteenth date, a weight is gradually increased from 0.9 to 1.1 according to progress of date from the first date to the fifteenth date. A ratio of a sum of weights from the first date to the fifteenth date to a sum of weights of days be given labels with existence of the specific behavior is calculated as the evaluation value. It can be said that higher the evaluation value is, higher a possibility at which the specific behavior is taken is.

As another calculation example of the evaluation value, the number of times of labels with existence of the specific behavior (the number of times of behavior) is determined itself as the evaluation value. It can be said that larger the number of times of behavior is, higher a possibility of the specific behavior being taken by the user is.

The evaluation value may be a rank instead of a value such as the behavior probability or the number of times of the behavior. For example, a range from 0 to 1 is divided in to a plurality of sections and an evaluation rank such as R1, R2, R3, . . . RN is set for each section. A size of each section is same or different. On that basis, as stated above, the behavior probability is calculated and the evaluation rank of the section of the calculated behavior probability is given. It can be said that larger “X” of RX indicating the rank is, higher a possibility of the specific behavior taken by the user is.

In a case that each time period for which the behavior estimation was performed does not coincide with each time period for which the evaluation value is calculated, a time period of the behavior estimation which overlaps the time period of calculating the evaluation value is specified. If there is at least one time period of the behavior estimation which is given the label with existence of the specific behavior, it can be regarded that the label with existence of the specific behavior is given for the time period for which the evaluation value is calculated, resulting in that the same processing as that described in the above can performed.

The calculation example as described here is one example, and another evaluation index can be used as long as the magnitude of possibility of the specific behavior taken by the user can be evaluated. In the explanation below, a case is assumed in which the behavior probability is calculated as the evaluation value.

As the behavior history data used for calculating the behavior probability, data on only a day or a time satisfying a predetermined condition can be used. For example, consider that a specific behavior is “at home” and the behavior probability is at home probability. The tendency of at home or go out is considered to be different between a weekday and a holiday in the ordinal house. Accordingly, at home probability of the weekday may be calculated from only the behavior history data of the weekday, and at home probability of the holiday may be calculated from only the behavior history data of the holiday.

According to meteorological situation such as weather, air temperature, amount of insolation or moisture, the tendency of at home or go out may be different. For the reason, for example, according to the weather, only data on the relevant weather may be used and the behavior probability may be calculated (at home probability at a time of clear weather, and at home probability of a time of rainy weather etc.). In this case, in the behavior history DB 34, not only the behavior label but also the meteorological information such as weather is also stored. The meteorological information may be acquired from externally a meteorological server (not shown in the figure). Alternatively, the meteorological sensor is arranged in the house, and from the meteorological sensor, the meteorological information may be collected via the communication network 3.

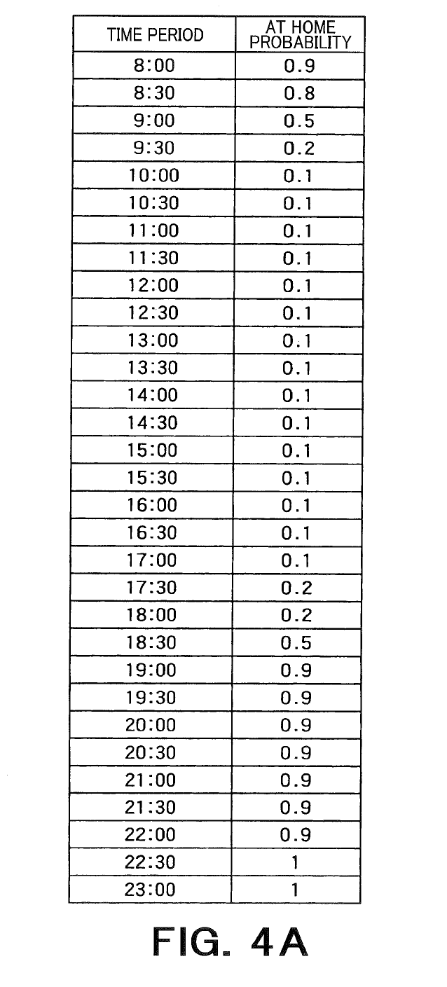

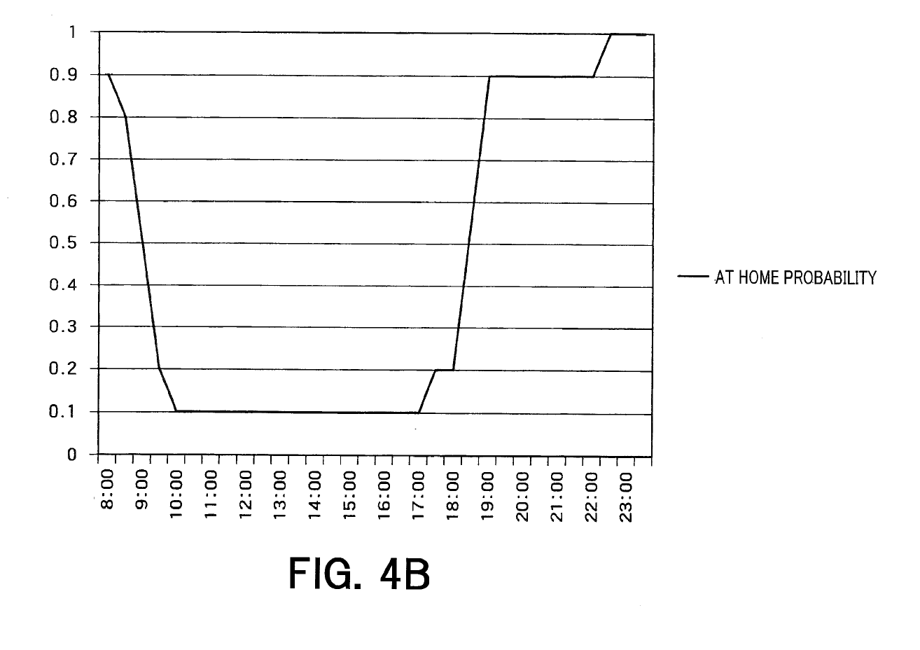

FIGS. 4A and 4B show an example of at home probabilities of user A for weekday, targeting a time span from Oct. 1, 2013 to Oct. 15, 2013. FIG. 4 A shows data in a tabular form. FIG. 4 B shows data in a graph form, which tracks smoothly the plotted data in FIG. 4 A.

The calculation example of at home probability for weekday is described below. During a time span from Oct. 1, 2013 to Oct. 15, 2013, there are 10 weekdays. For the 10 weekdays, for each time period at a time interval of 30 minutes, at home probability is calculated as below. The relevant behavior labels are taken for 10 days from H:00 to H:30 (H is greater or equal to than 8 and less or equal to than 23). Among the taken behavior labels, when a number of behavior labels showing “at home” is N, N is divided by 10 (i.e., N/10) to thereby calculate “at home probability” of the time period from H:00 to H:30. In the same manner, also for a time period from H:30 to H+1:00, at home probability can be calculated. “at home probability” may be generally expressed by decimal number. In the example shown in the figure, a number of significant figures is 1 digit after the decimal number: however, the present embodiment is not limited to this. As one example, a number of significant figures can be varied according to accuracy at which the behavior label is given.

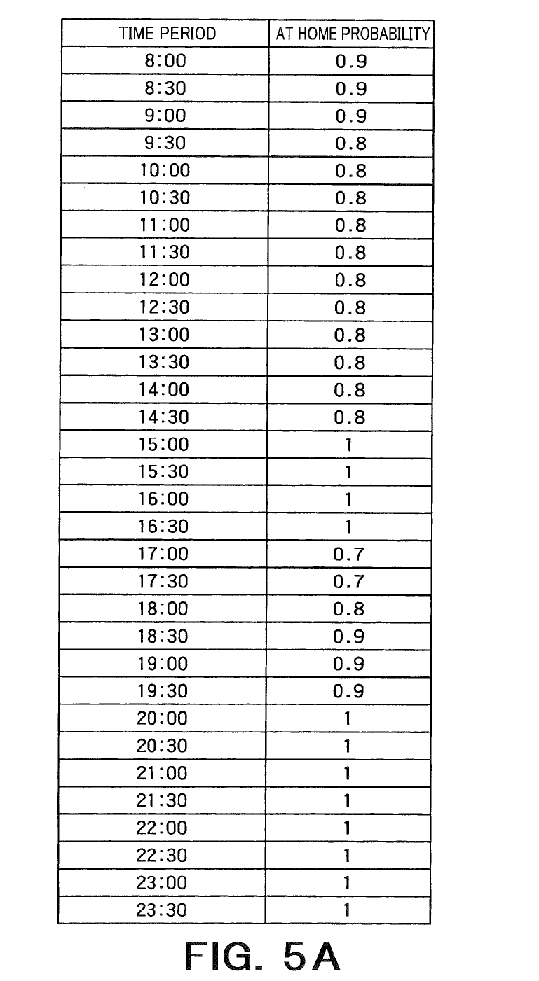

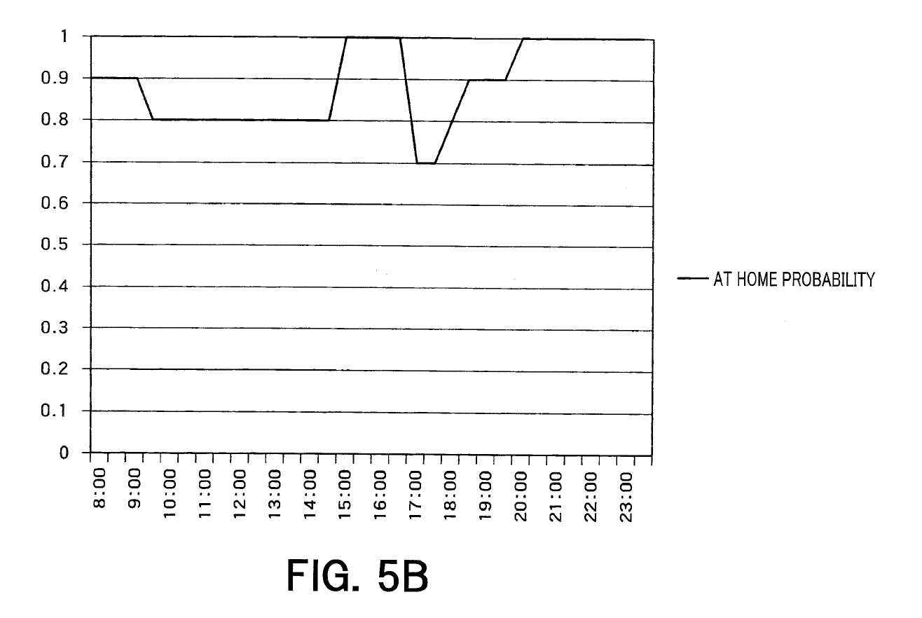

FIGS. 5A and 5B show an example of at home probabilities of user B different from FIGS. 4A and 4B for weekday. As is the case with FIG. 4 A and FIG. 4 B, FIG. 5A shows data in a tabular form and FIG. 5 B shows data in a graph form. The calculation method of at home probabilities is obvious from the explanation made regarding FIG. 4 and thus the explanation thereof is omitted.

Due to temporary variation of a life style, there may be a case that for many time periods in a day, the behavior labels having low coincidence with respect to other days in the behavior history data are given. For example, there is a case that 9 days out of 10 days, the user is not at home in morning and daytime (i.e. going out in morning and daytime) and only one day of the 10 days, the user is at home due to bad health. The data obtained due to the thus temporarily variation is hopefully not used for calculation of the behavior probability. Therefore, the following configuration can be employed that when the behavior labels having low coincidence with respect to other day are given to many time periods in a day, data on the date is not used for calculation of the probability. For example, for time periods of a number greater or equal to than a preset number M, the behavior labels different from those given to other 9 days are given to a day, data on that day is not used for calculation of the behavior probability.

The profile candidate storage 47 stores profile candidate data which associates a plurality of profile candidates with a plurality of selection conditions where the profile candidates each indicate tendency of time periods at which the specific behavior occurs and the selection conditions are conditions for selecting the profile candidates. The profile candidate data has, for example, a tabular form, and in the present embodiment, the profile candidate data is a profile candidate table. The selection conditions each define constraint on an evaluation value for a predetermined one time period or a plurality of time period. When the selection condition is satisfied, this means that the corresponding profile candidate can be selected as a profile of the user. The content of profile candidate storage 47 may be registered and updated by an operator via the input circuit 51

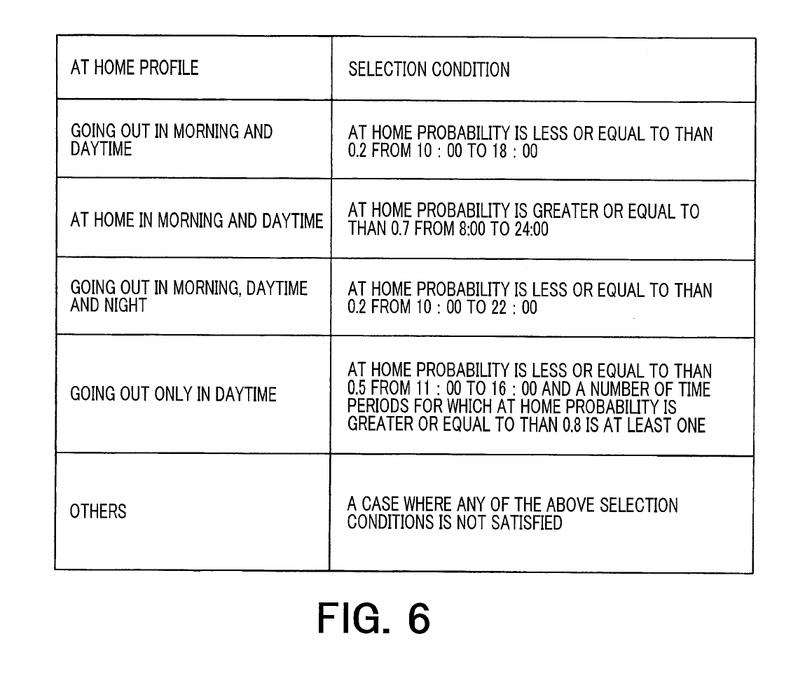

FIG. 6 shows data example stored in the profile candidate storage 47. The data example shows a case where the specific behavior is “at home”. In the left column of the table, five profile candidates are shown; “going out in morning and daytime”, “at home in morning and daytime”, “going out in morning, daytime and night”, “going out only in daytime” and “others”.

In the right column of the table, the selection conditions corresponding to the respective profile candidates are shown. For example, the selection condition corresponding to “going out in morning and daytime” is “at home probability is less or equal to than 0.2 from 10:00 to 18:00”. This means a condition that in each time period of a specified time span from 10:00 to 18:00, at home probability is less or equal to than 0.2. When the condition is satisfied, the corresponding profile candidate “going out in morning and daytime” is selectable. Specifically, when the selection condition is satisfied, the user tends to go out in morning and daytime as the tendency of the time periods at which the specific behavior (here, at home) is taken.

The selection condition corresponding to “going out only in daytime” is “at home probability is less or equal to than 0.5 from 11:00 to 16:00 and a number of time periods for which at home probability is greater or equal to than 0.8 is at least one”. This means a condition that in each time period of a specified time span from 11:00 to 16:00, at home probability is less or equal to than 0.5, and in a specified time span from 10:00 to 18:00, a number of time periods for which at home probability is greater or equal to than 0.8 is at least one. Specifically, when the selection condition is satisfied, the user tends to mostly go out only in daytime as the tendency of the time periods at which the specific behavior (here, at home) is taken.

In the example shown in FIG. 6, the selection condition is defined based on the behavior probability (at home probability). Alternatively, when the evaluation value is calculated in a format of an evaluation rank, the selection condition may be defined based on the evaluation rank. For example, when defining that the evaluation rank is any one of R8 to R10, it may be described such as “evaluation rank=“R8” OR “R9” OR “R10”.

The profile setter 43 sets a profile on the user based on temporally trajectory form of behavior probabilities (evaluation values) of respective time periods with respect to the target user. The “temporally trajectory form of behavior probabilities (evaluation values) of respective time periods with respect to the target user” is, for example, trajectory form tracing data points into which, in a coordinate system where a horizontal axis indicate a time and a vertical axis indicates an evaluation value, the evaluation values of respective time periods in the target user are developed. The profile setter 43 determines whether the behavior probabilities (evaluation values) of respective time periods with respect to the target user satisfy each selection condition corresponding to each profile candidate in the profile candidate storage 47. The profile setter 43 detects the profile candidate corresponding to the satisfied selection condition and sets the detected profile candidate as the profile of the user (at home profile). Specifically, the profile setter 43 includes a detector 39a and a setter 39b. The detector 39a detects, based on the selection conditions of the profile candidates in the profile candidate storage 47, the profile candidate corresponding to the selection condition which the behavior probabilities (evaluation values) of respective time periods with respect to the target user satisfy. The setter 39b sets the profile candidate detected by the detector 39a as the user's profile. As stated above, the selection condition defines constraint on evaluation values for a plurality of time period. Therefore, by comparing evaluation values of respective time periods of the target user with the selection conditions, it is possible to evaluate temporally trajectory form of evaluation values of respective time periods.

Based on the data example shown in FIG. 6, an example is described that determines whether a target user satisfy the selection condition corresponding to “going out in morning and daytime”. With respect to the target user, for each time period at a time interval of 30 minutes, i.e., 10:00 to 10:30, 10:30 to 11:00, 11:00 to 11:30, . . . , 17:30 to 18:00, whether at home probability (evaluation value) is less or equal to than 0.2 is determined. When in all of the time periods, at home probability is less or equal to than 0.2, the selection condition is satisfied. Therefore, in this case, the profile candidate “going out in morning and daytime” is detected. The selection conditions corresponding to other profile candidates are also judged of whether they are satisfied in the same way and the profile candidate(s) corresponding to the satisfied selection condition(s) are all detected.

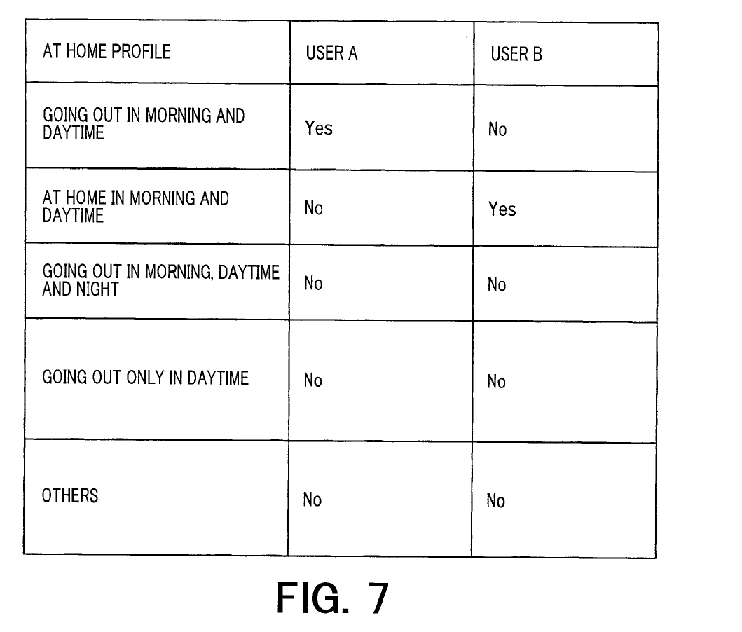

For example, in the case of at home probability of the user A as shown in FIG. 4 A, the selection condition corresponding to “going out in morning and daytime” is satisfied and the other selection conditions corresponding to other profile candidates such as “at home in morning and daytime” etc. are not satisfied. On the other hand, in the case of at home probability of the user B as shown in FIG. 5, the selection condition corresponding to “at home in morning and daytime” is satisfied and the other selection conditions corresponding to other profile candidates such as “going out in morning and daytime” etc. are not satisfied. FIG. 7 collectively presents condition determining results for the user A and the user B. “Yes” means that the selection condition is satisfied and “No” means that the selection condition is not satisfied.

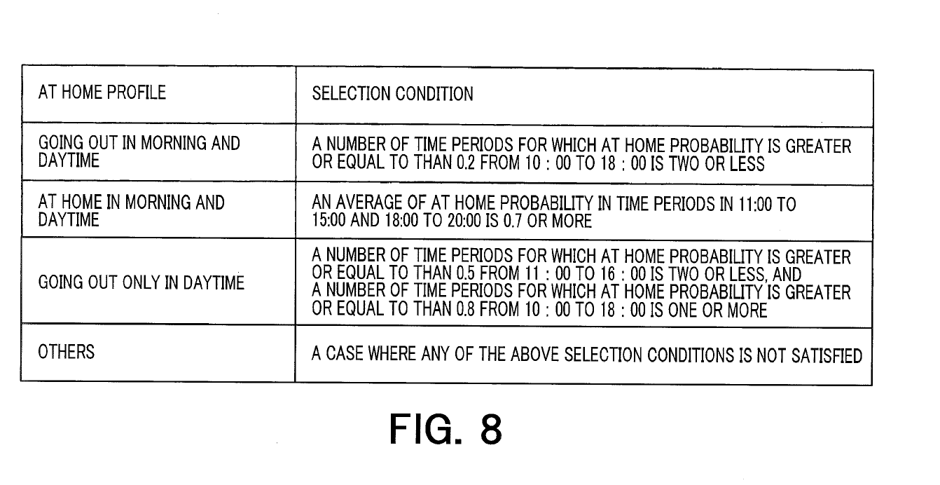

FIG. 8 shows another data example stored in the profile candidate storage 47.

The profile candidates “going out in morning and daytime”, “at home in morning and daytime”, “going out only in daytime” and “others” and the selection conditions corresponding to these profile candidates are shown. Compared with FIG. 6, definition of the selection conditions corresponding to the profile candidates are different. Furthermore, the profile candidate “going out in morning, daytime and night” and the corresponding selection condition, which are present in FIG. 6, are not present in FIG. 8.

In FIG. 8, the selection condition corresponding to “going out in morning and daytime” is relaxed compared with that shown in FIG. 6. In FIG. 6, it is required that in a time span from 10:00 to 18:00, at home probability of each time period is less or equal to than 0.2. To the contrary, in the example shown in FIG. 8, even if there is the time period(s) having at home probability more than 0.2 in the time span from 10:00 to 18:00, the selection condition is satisfied if a number of the time period(s) is less or equal to than 2.

This is because temporary variation of the behavior due to a sudden event etc. is considered and the condition is relaxed at a reasonable degree. For example, assumed that 7 days of 10 weekdays, the user is not at home from 10:00 to 18:00, and the user is at home from 10:00 to 18:00 due to a cold 2 days out of the remaining 3 days and goes home due to having a thing to do temporarily at 12:00 in the daytime the remaining 1 day. In this case, during 10 days, at home probability of 12:00 to 12:30 is 0.3. This value is larger than 0.2 and therefore, in the example of FIG. 6, the selection condition corresponding to “going out in morning and daytime” is not satisfied. To the contrary, in the example of FIG. 8, even if there is a time period(s) having the value more than 0.2, it is allowable as long as the number of the time period(s) is less or equal to than 2. Accordingly, in the example of FIG. 8, the selection condition corresponding to “going out in morning and daytime” is satisfied.

For the same reason as stated above, the selection condition corresponding to the profile candidate “going out only in daytime” is also relaxed compared with the case of FIG. 6. Specifically, in the example of FIG. 8, during 11:00 to 16:00, at home probability having the value more than 0.5 is allowable up to 2.

Also as for the profile candidate “at home in morning and daytime”, in the example of FIG. 8, constraint is not set during 15:00 to 18:00 compared with the example of FIG. 6. That is, at home probability of each time period during 15:00 to 18:00 can be any value. This is because it is considered that during 15:00 to 18:00, the user is not at home due to shopping of foods etc. In a case of ignoring absence (i.e., not at home) due to the behavior usually performed by a house keeper to grasp at home tendency, the selection condition can be effectively used. As seen above, the selection condition defined on the profile candidate may be determined depending on whether what user is to be given what profile.

In the selection condition corresponding to “at home in morning and daytime” in FIG. 8, an average of at home probabilities of the time periods in both 11:00 to 15:00 and 18:00 to 20:00 is required of greater or equal to than 0.7. By using the average, a sudden behavior variation is considered to relax constraint. Thereby, for example, even if such behavior variation occurs that in many time periods in both 11:00 to 15:00 and 18:00 to 20:00, at home probability is 1.0 although only in a certain time period, at home probability is 0.6 less than 0.7, it becomes possible to detect the profile candidate “at home in morning and daytime”.

So far, by using FIG. 6 and FIG. 8, some selection conditions are exemplified. Generally, a selection condition can be described under rules as shown below. The rules merely show one example and the rules shown here are not necessary all. Below, values X, Y, P and N are used to generally describe a selection condition. These values may be different among the selection conditions. The expression “greater or equal to/less or equal to” represents to use selectively either one of “greater or equal to” and “less or equal to”.

rule 1: a behavior probability of each time period in a time span from time point X to time point Y is all less or equal to/greater or equal to P.

rule 2: an average of behavior probabilities of time periods in a time span from time point X to time point Y is less or equal to/greater or equal to P.

rule 3: a number of time periods for which behavior probabilities are greater or equal to/less or equal to N in a time span from time point X to time point Y is greater or equal to/less or equal to N.

rule 4: a behavior probability of each time period in a time span from time point X to time point Y increases/decreases according to time.

rule 5: in rules 1 to 4, a plurality of the time spans being not temporally successive are arranged. For example, a time span from time point X to time point Y and a time span from time point W to time point Z are arranged (where Y<W).

rule 6: two or more selection conditions according to at least one of rules 1 to 5 are combined by logical product (AND operation).

rule 7: two or more selection conditions according to at least one of rules 1 to 6 are combined by logical addition (OR operation).

The rule 1 is effective in a case that the specific behavior is required to keep a high probability in a specified time span. Also, the rule 1 is effective when the specific behavior is required to probabilistically hardly occur in a specified time span. The selection conditions corresponding to “at home in morning and daytime” and “going out in morning and daytime” in FIG. 6 are this case.

The rule 2 handles an average of behavior probabilities instead of a behavior probability itself. Thereby, the rule 2 is effective when a case is allowed that the behavior probabilities are 1.0 in most time periods although only in a certain time period, the behavior probability is less than a predetermined. When variation of a human behavior due to a sudden event etc. is allowed to some extent, the rule can be used instead of rule 1.

The rule 3 is to allow exception to the rule 1 for only time periods the number of pieces of which is greater or equal to/less or equal to N. When variation of a human behavior due to a sudden event etc. is allowed to some extent, the rule can be used instead of rule 1.

The rule 4 is effective in a case of checking whether the behavior occurs one time within a specified time span.

For example, when the behavior probability gradually increases in the specified time span, this means that a probability at which the behavior occurs within the specified time span gradually increases. For example, assumed that there are user A and user B for each of which at home probability is 0 until 16:00 and, afterward at home probability increases to 1 on or before 20:00. With respect to user A, at home probability monotonically linearly increases from 0.1 to 0.9 during a time span immediately after 16:00 and immediately before 20:00. This corresponds to a case where in the house of user A, any resident goes home during a time span from 16:00 to 20:00 and a time to go home is not fixed or not steady during the time span from 16:00 to 20:00.

On the other hand, with respect to user B, assumed that from 16:00 to 20:00, at home probabilities of 0.1 and 0.9 alternately occurs. This corresponds to a case where in the house of user B, a resident continues to go home once and then go out (for example, the resident goes home once and then goes out for dining-out or a club activity etc.).

In order to detect such features in user A that the time to go home is fixed although a change from “not at home” to “at home” occurs only one time during a time period from 16:00 to 20:00, a selection condition can be used that at home probability monotonically increases from 16:00 to 20:00. In user B, because at home probability iterates up and down between 0.1 and 0.9 but does not monotonically increase, user B does not satisfy the selection condition.

Other than simply checking of the monotonic increase as described above, the following method is considered. Specifically, such a rule is allowed that even if trajectory of behavior probabilities of time periods in a specific time period from t1 to t2 slightly vibrate, the behavior probability increase above a certain range as the whole of the specific time period. The rule can be specified by the following two equations:

|Pᵢ−Pᵢ₊₁|>e (for each i (t1=<i<t2))

Pₜ₂−Pₜ₁>C [Formula 1]

where “e” is a small negative value (e.g., −0.1) and “C” is a positive constant value (e.g., 0.6). According to this example, not only simple monotonically increase but also the following case is allowed that the probability does not necessarily increase timewise but slightly decrease by a small negative value being given to “e”: however, at the end of the time period from t1 to t2, the probability finally increases above “C” compared with the first probability of t1. This rule can be used instead of the rule for checking the monotonically increase as described previously.

In the same way as the case of the increase, a case of decrease is allowed where in order to detect the feature that the behavior changes from “at home” to “not at home” one time in the specified time span, the selection condition defining the decrease of the at home probability within the specified time span is used.

Other than simply checking of the monotonic decrease, the following method is, similarly to the case of the increase, considered. Specifically, such a rule is allowed that even if trajectory of behavior probabilities of time periods in a specific time period slightly vibrate, the behavior probability decrease below a certain range as the whole of the specific time period (at the end of the specific time period, the probability finally largely decreases compared with the first probability at the start of the specific time period).

The rule 5 is effective in a case of considering two or more time spans being not temporally successive.

The rule 6 and the rule 7 are effective in a case of considering more complex condition.

The setter 39b in the profile setter 43 sets the profile candidate detected by the detector 39a from the profile candidate storage 47 for the target user as the profile thereof. The setter 39b in the profile setter 43 registers the profile set for the target user in the profile setting storage 48.

FIG. 10 shows a data example of profiles set for users A, B and C. In this example, the profile “going out in morning and daytime” is set for user A, the profile “at home in morning and daytime” is set for user B, and the profile “others” is set for user C.

When a plurality of profile candidates are detected, all of the detected profile candidates may be set for the target user as the profile thereof or the following method may be used.

For example, when there is inclusion relation among the profile candidates, only the broader one of the profile candidates is set for the target user as the profile thereof. It is assumed that the profiles “going out in morning and daytime” and “going out in morning, daytime and night” are detected for a target user. In this case, by regarding that “going out in morning, daytime and night” includes “going out in morning and daytime” and therefore, only “going out in morning, daytime and night” is set. In order to perform such processing, the inclusion relation among the profile candidates is previously registered in the profile candidate storage 47.

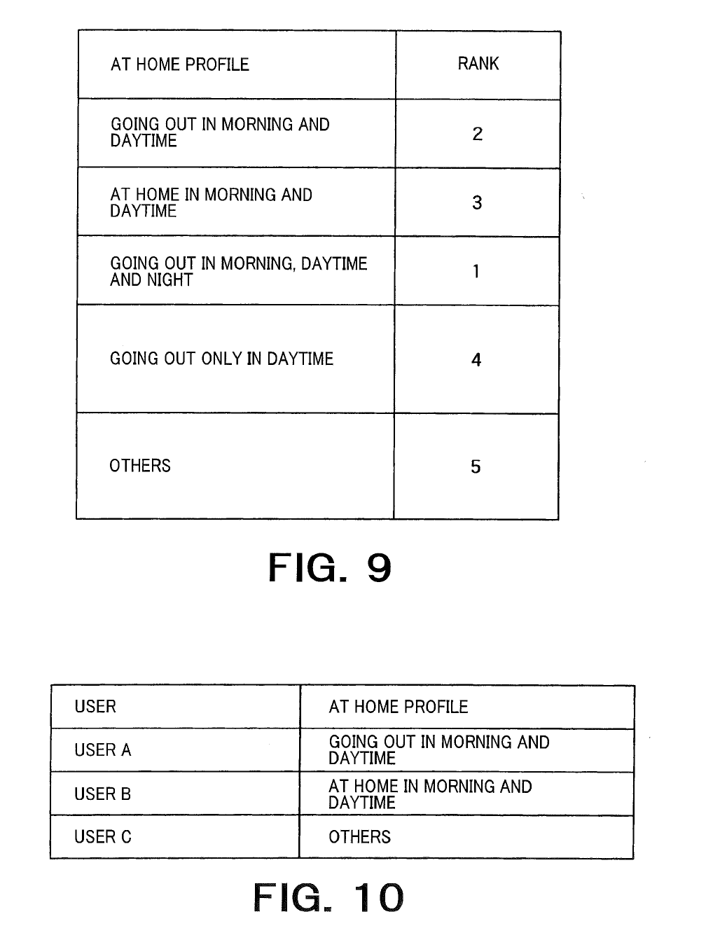

Alternatively, the following method is allowed that priorities are preset on each profile candidate and a predetermined number of profile candidates having the high priority are detected to set them on the target user as the profile thereof. The predetermined number may be one, two or more. FIG. 9 shows an example of a table in which priorities are set on the profile candidates related to the specific behavior of “at home” (or “going out”). This priority table is previously registered in the profile candidate storage 47. In this example, “going out in morning, daytime and night” (i.e., not at home in morning, daytime and night) has a highest priority. The above inclusion relation-based profile setting can be also realized by this priority table.

The attribute storage 49 stores attribute data which associates a plurality of profile with information attribute of offer information. The attribute data has a tabular form, for example, and in the present embodiment, the attribute data is an attribute table. The attribute storage 49 may be registered and updated via the input circuit 51 by an operator.

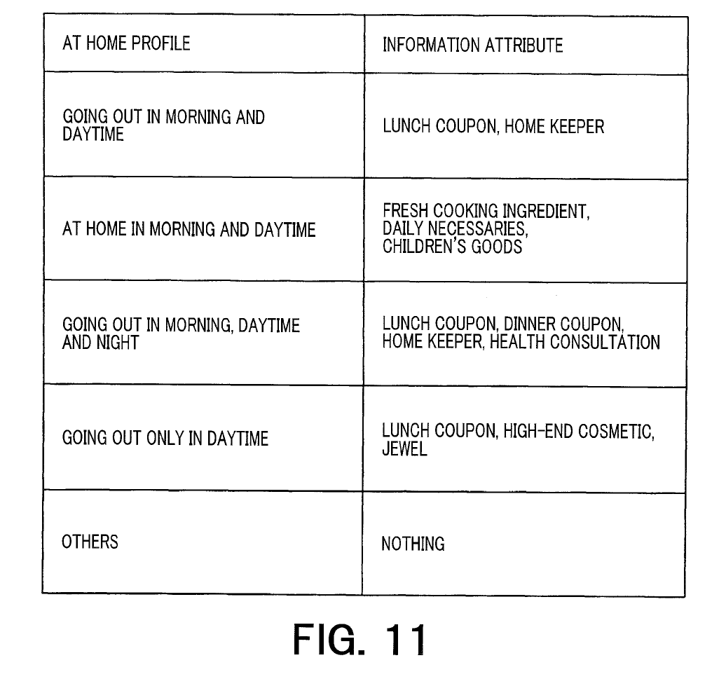

FIG. 11 shows an example of the attribute table. On each profile related to the specific behavior of “at home” (or “going out”), the information attribute is set.

For the profile “at home in morning and daytime”, information attributes are set of “fresh cooking ingredient”, “daily necessaries” and “children's goods”. This is because it is considered that the user having this profile has a house keeper in the house at a high possibility and thus, the offer information having these attributes can be effectively defined.

Also, for the profile “going out in morning, daytime and night” (“not at home in morning, daytime and night”), information attributes are set of “lunch coupon”, “dinner coupon”, “home keeper” and “health consultation”. This is because it is considered that the user having this profile is a busy single business man or double income household at a high possibility and thus, the offer information having these attributes can be effectively defined.

Also, for the profile “going out only in daytime”, information attributes are set of “lunch coupon”, “high-end cosmetic” and “jewel”. This is because it is considered that the user having this profile has a house keeper going out for lunch on a daily basis and is comparatively wealthy family at a high possibility and thus, the offer information having these attributes can be effectively defined.

In the example of FIG. 11, information attributes are mostly attributes of advertisement information for a profit on commodities or services. Other than those, attributes of advertisement information for a non-profit can be also defined such as advertisements of a government and local governments. Still, other than the advertisements, an information attribute of advice on healthcare can be also defined.

The attribute setter 44 specifies, based on the attribute table in the attribute storage 49, the information attribute corresponding to the profile set by the profile setter 43, and sets the specified information attribute on the target user. When the profile “going out in morning and daytime” is set on the target user in FIG. 11, the two information attributes “lunch coupon” and “home keeper” are specified and set on the target user.

The attribute setter 44 registers the information attribute which is set on the target user in the attribute setting storage 50 together with the profile which is set on the target user. The attribute setting storage 50 stores a setting table in which the profile and the information attribute(s) are stored per user.

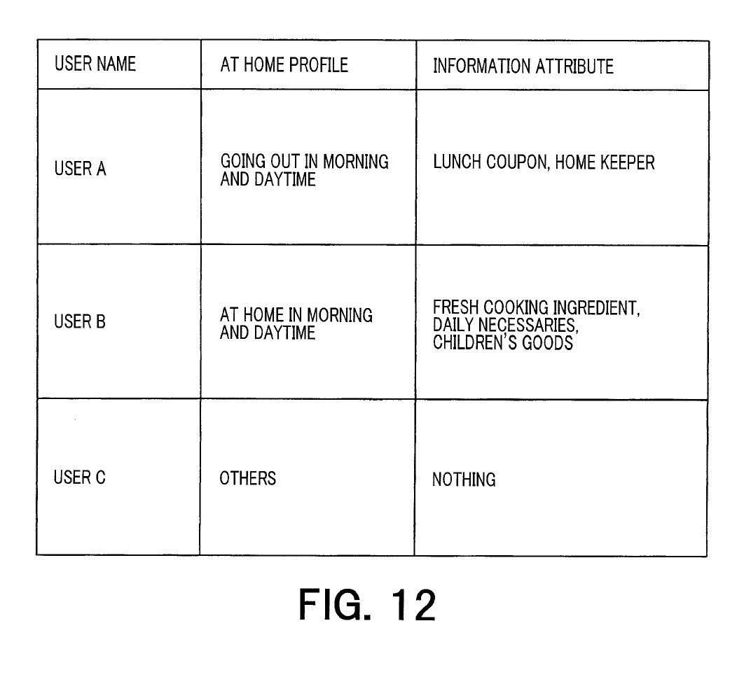

FIG. 12 shows an example of information attributes set for users A, B and C. For example, the information attributes “lunch coupon” and “home keeper” are set on the user A.

The offer information storage 37 stores information providing table which associates the information attribute, the offer information and information detail with each other. The offer information corresponds to data actually transmitted to the user. The information detail indicates interpretation (or comment) on the content of the offer information. In a field of the offer information, a pointer linked to data actually transmitted is set and the data is read from a memory area pointed by the pointer for transmission. A text in the information detail field may be transmitted to the output device 22. In this case, the output device 22 displays the text and can thereby encourage the user to comprehend the content of the offer information in more detail. The content of the offer information storage 37 may be registered or updated via the input circuit 51 by an operator.

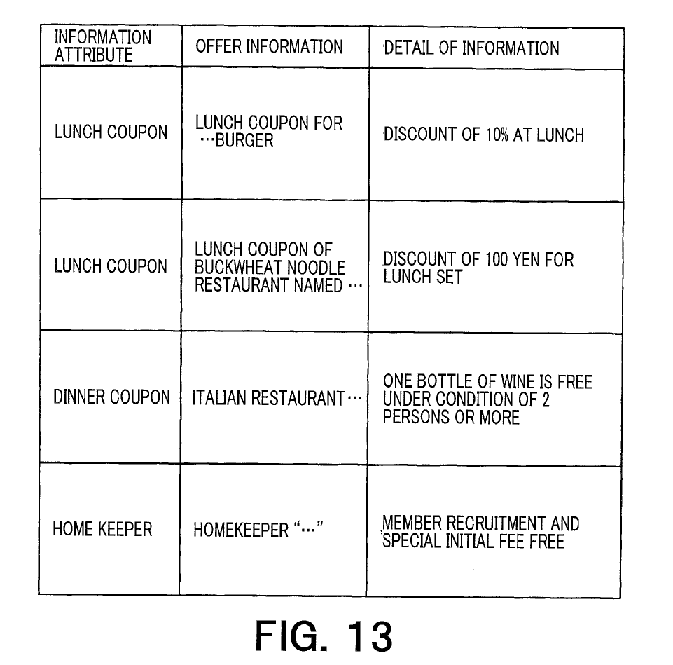

FIG. 13 shows an example of the information providing table stored in the offer information storage 37. The two information attributes “lunch coupon”, “dinner coupon” and “home keeper” are registered. Also, correspondingly to the attributes, the offer information as data and information detail are registered. For example, corresponding to the information attribute “lunch coupon” at a first row, data of the offer information data “lunch coupon for . . . burger” is stored. The content of the coupon is described in the information detail field, which indicates discount of 10% at lunch.

The offer information transmitted to the target user may any one of text data, image data and voice data, or any combination thereof. For example, it may be HTML data in which image data and text data are combined. The HTML data may include a link to a specific URI. Thereby, the user's output device 22 accesses to a place pointed by the URI and accesses the coupon for use.

As is the case for user C in FIG. 12, when the profile set for the user is “others”, the information attribute may not be set or selected randomly from previously provided candidates of the information attribute.

The information transmission processing unit 45 reads out the information attribute which is set on target user from the attribute setting storage 50. The information transmission processing unit 45 selects one or a plurality of offer information to be provided to the target user based on the as read-out information attribute from the offer information storage 37. The information transmission processing unit 45 acquires the selected offer information from the offer information storage 37 and transmits the offer information to the output device 22 of the target user. An address of the output device 22 of each user is previously registered. When the user has a plurality of output devices, the unit 45 may transmit the offer information to the plurality of output devices. For example, when the user is a family of 3 persons and each person has an output device, the offer information can be provided to each person. The information transmission processing unit 45 may transmit the offer information to the output device 22 only when receiving a request of providing information from the output device 22, or periodically transmit the offer information. The providing of information to the output device 22 is performed via the communication network 3 and therefore the information may be transmitted to a device possessed by a person or an organization which is related to the user but not necessarily the device possessed by the user. That is, the information transmission processing unit 45 transmits the device possessed by the user or the device possessed by the person or the organization which is related to the user (each device corresponds to an output device related to the user). For example, when the user is an aged couple living only on couple's own and the user's son/daughter lives away from home, a case is considered where in order to let the son/daughter know the user′ lifestyle, it is meaningful to exhibit profile information and provide the relevant service information. In this case, the information providing table directed to “the user's son/daughter” is separately provided, and the information to aid the support for the user (parent) by the son/daughter is provided. For example, if the user (parent) is “not at home in morning and daytime”, “home security” is recommended to the son/daughter. Similarly, if the user is a student living alone, information on the user's lifestyle may be delivered to the user's parent through the profile information.

In the information table example in FIG. 13, three items, that is, “lunch coupon” at the first row, “lunch coupon” at the second row and “home keeper” at the fourth row are matched with the information attribute (FIG. 12). Therefore, the information transmission processing unit 45 selects all of the offer information corresponding to the three items (information attributes), as one example. Alternatively, when the number of the matched items is two or more, one item may be selected randomly.

Alternatively, when the number of the information attributes which is set on the user is two or more, one information attribute is randomly selected before accessing the information table and then the offer information corresponding to the item matched with the selected information attribute may be selected in the information table. The number of the items matched with the selected information attribute is two or more, one item may be selected randomly. For example, when the information attributes “lunch coupon” and “home keeper” are set on the user, one of “lunch coupon” and “home keeper” is selected randomly. When “lunch coupon” is selected, the item matched with “lunch coupon” is specified in the information table. In the example of FIG. 13, the number of the items matched with “lunch coupon” is two, and any one of the items is selected randomly.

In the above, the case is presented which randomly selects the offer information: however, other than the case, a case is considerable where the offer information is selected depending on a sex of the user. In this case, the address of the output device and the sex of the user are previously managed so as to be associated with each other. Alternatively, the following method is allowed that day and time at which the offer information is updated is managed in the information table and latest offer information is preferentially selected.

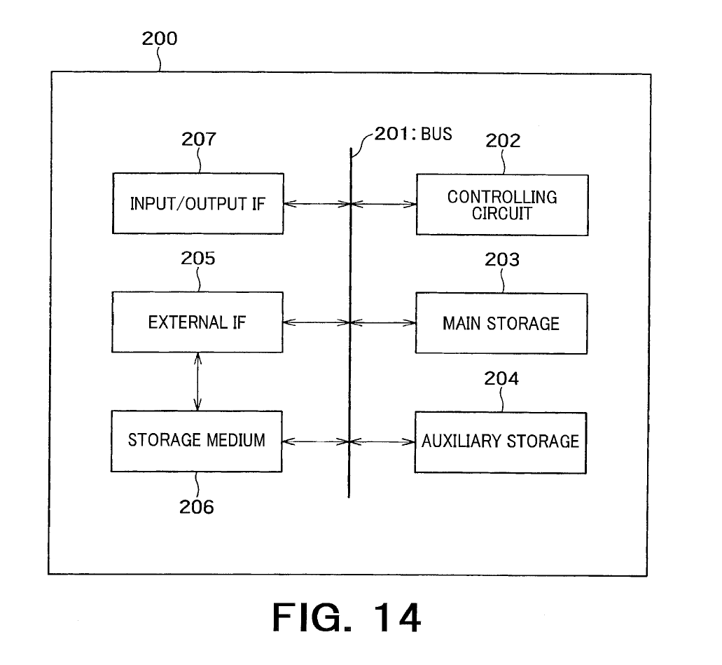

The information providing server 2 or information providing device 41 shown in FIG. 1 may also be realized using a general-purpose computer device as basic hardware, as shown in FIG. 14. In the computer device 200, a controlling circuit (processor) 202, a main storage (memory) 203, an auxiliary storage 204 such as hard disk are connected to a bus 201. Through an external IF 205, a storage medium 206 is connected and through an input/output IF 207, the input circuit 51 or the output circuit 52 is connectable. Each processing block in the information providing server 2 or the information providing device 41 can be realized by causing a processor 202 mounted in the above described computer device to execute a program. In this case, the information providing server 2 or the information providing device 41 may be realized by installing the above described program in the main storage 203 or the auxiliary storage 204 of the computer device beforehand or may be realized by storing the program in a storage medium 206 such as a CD-ROM or distributing the above described program over a network and installing this program in the computer device as appropriate. Furthermore, each storage in the information providing server 2 or the information providing device 41 may also be realized using a main storage 203 or an auxiliary storage 204 incorporated in or externally added to the above described computer device or a storage medium 206 such as CD-R, CD-RW, DVD-RAM, DVD-R as appropriate.

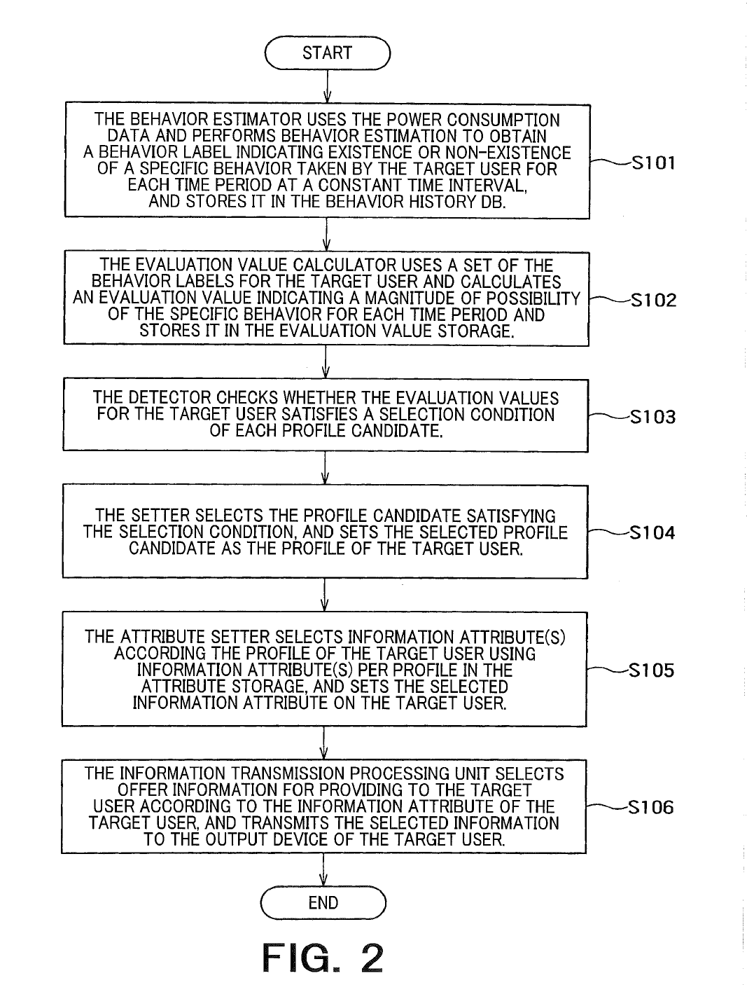

FIG. 2 is a flow chart of an operation performed by the information providing server 2 according to the present embodiment.

(step S101) The behavior estimator 33 uses the power consumption data in the power consumption DB 32 and performs behavior estimation on existence or non-existence of a specific behavior taken by the target user for each time period at a constant time interval. The behavior estimator 33 gives a behavior label indicating the estimation result to the time period. Thereby, the behavior estimator 33 acquires behavior history data which indicates a history of day and time of occurrence of the specific behavior taken by the user. The behavior estimator 33 stores the acquired behavior history data in the behavior history DB 34.
(step S102) The evaluation value calculator 42 uses a set of the behavior labels obtained for the target user and calculates an evaluation value (behavior probability etc.) for each time period wherein the evaluation value indicates a magnitude of possibility of the specific behavior taken by the user. The evaluation value calculator 42 stores the calculated evaluation value to be associated with the relevant time period in the evaluation value storage 46.
(step S103) The detector 39a of the profile setter 43 checks whether the evaluation values calculated by the evaluation value calculator 42 satisfies a selection condition of each profile candidate.
(step S104) The setter 39b of the profile setter 43 selects the profile candidate determined by the detector 39a, which satisfies the selection condition among the profile candidates, and sets the selected profile candidate on the target user as the profile of the target user. The setter 39b of the profile setter 43 stores the set content in the profile setting storage 48.
(step S105) The attribute setter 44 selects an information attribute(s) according the set profile of the target user from an attribute table which indicates an information attribute(s) per profile in the attribute storage 49. The attribute setter 44 sets the selected information attribute on the target user. The attribute setter 44 stores the set content in the attribute setting storage 50.
(step S106) The information transmission processing unit 45 selects offer information to be provided to the target user according to the information attribute of the target user from the offer information storage 37. The information transmission processing unit 45 reads out the selected information from the offer information storage 37 and transmits that to the output device 22 of the target user.

Before step S101 starts, the following step may be added that an operator may handle the input circuit 51 and performs registration or update on the profile candidate storage 47 or the attribute storage 49.

The flow of FIG. 2 may be periodically performed such as once every two weeks, or performed according to an instruction input at any timing by the operator of the input circuit 51 and the output circuit 52. The step S106 is an independent timing from steps S101 to S105. For example, steps S101 to S105 may be performed once every two weeks while the step S106 may be performed once every day or correspondingly to the request transmitted from the output device 22 to the information transmission processing unit 45.

In the present embodiment, as shown in FIG. 1, the data collector 31 which collects power consumption data, the power consumption DB 32 which stores power consumption data, the behavior estimator 33 which performs behavior estimation, the behavior history DB 34 which stores behavior history data, the offer information storage 37 which stores offer information and the information providing device 41 etc. are collectively configured as one server. As a variation, these elements may be dispersed over a plurality of servers.

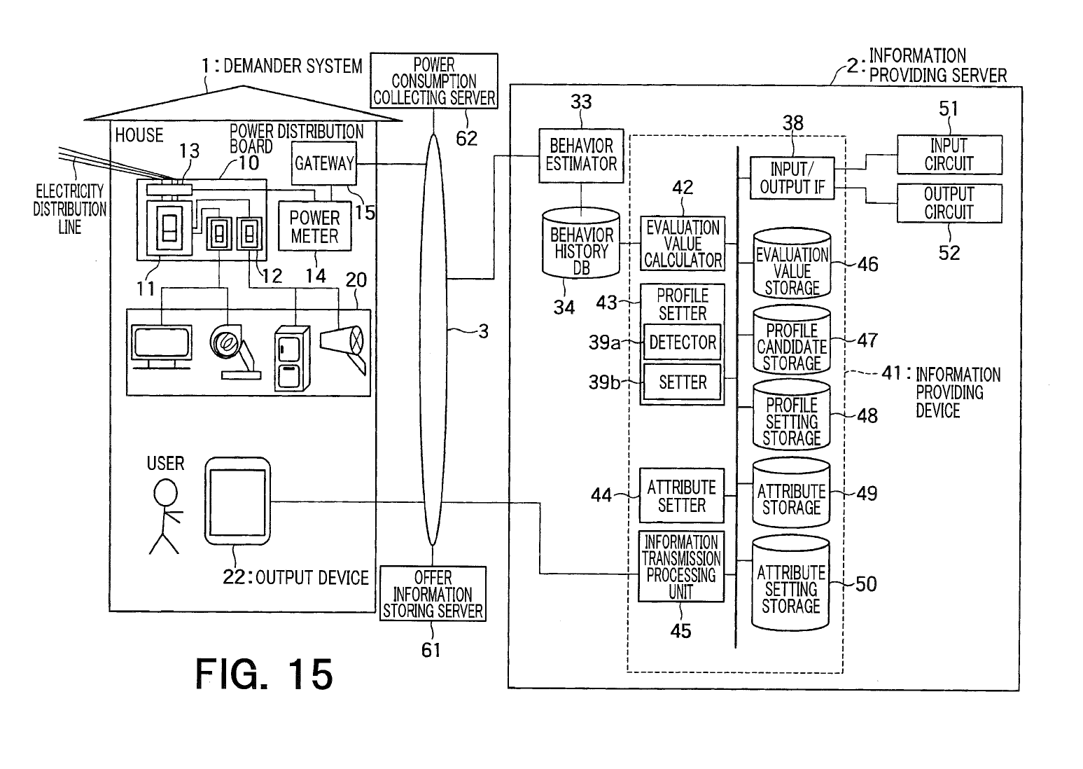

FIG. 15 illustrates a variation of the information providing system in FIG. 1. In the example, the offer information storage is replaced with an offer information storing server 61, and the data collector and the power consumption DB are replaced with the power consumption collecting server 62. The servers 61 and 62 are connected to the communication network 3, respectively. The behavior estimator 33 of the information providing server 2 communicates via the communication network 3 with the power consumption collecting server 62 to acquire the power consumption data required for behavior estimation. The information transmission processing unit 45 communicates via the communication network 3 with the offer information storing server 61 acquires the offer information for providing to the user. The behavior estimator 33 and the behavior history DB 34 may be also placed in the communication network 3 as a behavior estimation server independently. In this case, the information providing device 41 acquires, via the communication network 3, behavior history data from the behavior estimation server. In this manner, when the servers are dispersed, the servers may be placed on different networks, respectively. For example, the power consumption collecting server 62 may be placed in the power company side and connected to a demander via a dedicated network. The power consumption collecting server 62 and information providing server 2 may be connected via a broad network such as the Internet, and the information providing server 2 and the offer information storing server 61 may be also connected via the broad network such as the Internet.

As stated above, according to the present embodiment, the evaluation value (behavior probability etc.) of the specific behavior such as at home for each time period is calculated and according the evaluation value of each time period, and the profile indicating the tendency of time periods at which the specific behavior occurs (or is taken) is set on the user. Then, according to the set profile, the offer information for providing to the user is determined and transmitted to the output device of the user. Thereby, information providing becomes possible to provide information which reflects the tendency of time periods of the specific behavior taken by the user. Therefore, it becomes possible to provide appropriate or effective information to the user.

Also, according to the present embodiment, a whole or a part of each day is divided into a plurality of time period, the behavior probability is evaluated for each time period, and the profile is set on the user. Therefore, compared with a case where the whole or the part of each day are not divided into the time periods and the behavior probability is evaluated for the whole or the part of each day, the profile setting can be made at high accuracy or high fineness. For example, in a case where the user goes out mostly every day during a time span from 6:00 to 7:00, and in other time period than the time span, the user is at home, if the possibility at which the specific behavior occurs is evaluated for a whole of each day, it will be only determined that the user tends to go out due to the user's going out mostly every day and thus the profile indicating tendency of the going out is set. In contrast, in the present embodiment, the behavior probability is evaluated for each time period as divided, such profile can be set that the user goes out from 6:00 to 7:00 and in other time period, the user is at home (for example, a profile “go outing only in morning”). In this way, the present embodiment focuses on that the behavior probability depends on each time period and based on this, enables to provide effective information and thus realizes the profile setting at high accuracy.

In the present embodiment, as the example of the profile candidate data, a table which associates the profile candidate with the selection condition is provided, the profile candidate satisfying the selection condition is detected from the table and set as the user's profile. As another example, the profile candidate data can be expressed, instead of in the tabular form, by a program having an IF-Then format. For example, IF-Then instructions such as IF(selection condition)-Then(profile candidate) is created according to each profile candidate and executed in series, resulting in that the profile candidate satisfying the selection condition is detected. IF(selection condition)-Then(profile candidate) means that when the selection condition is satisfied, the profile candidate under Then is detected.

### Second Embodiment

The present embodiment is different from the first embodiment in view of a method for setting the profile. The block diagram of the present embodiment is FIG. 1 which is same as that of the first embodiment. Below, a difference from first embodiment is mainly explained.

In the present embodiment, a plurality of reference data are provided which indicate reference values of the time periods, respectively. Each reference data is associated with a profile candidate. Profile candidate data (profile candidate table) includes the plurality of reference data and the profile candidates associated each other. A similarity level of each reference data is calculated according to a difference between the evaluation value of each time period in the user calculated by the evaluation value calculator 42 and the reference value of each time period in each reference data. The similarity level expresses a degree of approximation between a first trajectory form and a second trajectory form where the first trajectory form is a temporal waveform of evaluation values of individual time periods in the user and the second trajectory form is a temporal waveform of evaluation values of individual time periods in the reference data. Higher the similarity level is, more approximate both waveforms are to each other. That the similarity level is high may be either case that the value thereof is large or small depending on definition of a calculating formula of the similarity level. In the present embodiment, assumed that smaller the value of the similarity level is, higher the similarity level is. By calculating the similarity level, it is possible to evaluate the temporally trajectory form of the evaluation values of the time periods in the user. In the present embodiment, based the similarity level of each reference data calculated as described above, one or a plurality of reference data are specified, the profile candidate(s) corresponding to the specified reference data is set on the user as the profile thereof. Below, the present embodiment is described in detail.

The profile candidate storage 47 stores the profile candidate data (profile candidate table) in which a plurality of reference data each indicative of reference values of the time periods and a plurality of profile candidates are associated with each other. In the present embodiment, assumed that the evaluation value is, as is the case of the first embodiment, the behavior probability (especially, at home probability), and the reference value is a reference probability.

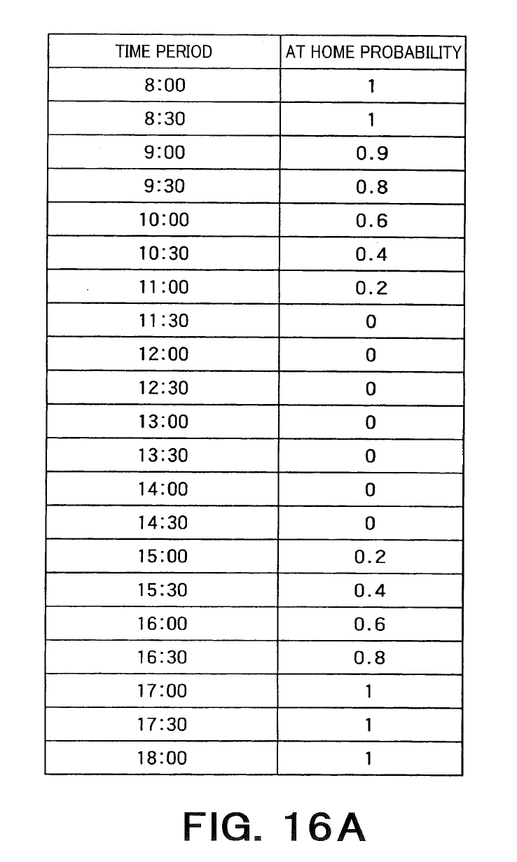

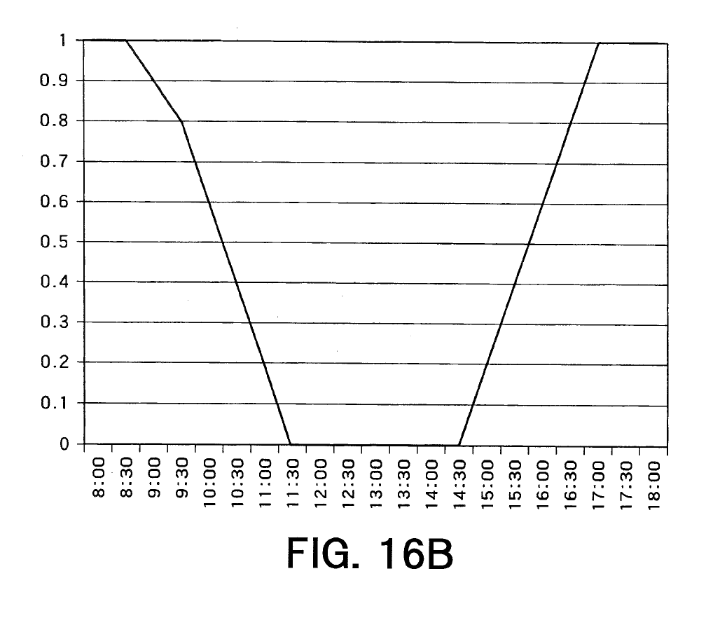

FIG. 16A and FIG. 16B show examples of the reference data. FIG. 16A shows data in a tabular form and FIG. 16 B shows the data transformed into a graph form.

The example of FIG. 16 A represents the reference probabilities of time periods at a time interval of 30 minutes from 8:00 to 18:00.

The detector 39a in profile setter 43 calculates the similarity level by a sum of absolute values of differences between the behavior probabilities of time periods calculated by the evaluation value calculator 42 and the reference probabilities of time periods in the reference data.

Below, targeting the time periods from time period t1 to time period t2, a calculating example of the similarity level is described. “Xt” indicates the user's behavior probability at time period t, and “Yt” indicates the reference probability at time period t.

$$\begin{matrix}[ Formula 2 ] & \\ {\sum }_{t = t 1}^{t 2} \vert Xt - Yt \vert & Equation 1\end{matrix}$$

The detector 39a in the profile setter 43 compares the similarity level calculated by equation 1 with threshold C and thereby specifies the reference data having the similarity level less or equal to than threshold C. The setter 39b in the profile setter 43 determines the profile candidate corresponding to the specified reference data as the user's profile. When a plurality of reference data are specified, the setter 43 may determine all of the profile candidates corresponding to the specified reference data to the user's profiles. As is the case of the first embodiment, one reference data out of the specified reference data may be selected by any method or a predetermined number of reference data may be selected on a higher priority basis.

As a variation, the time period may be weighted as the following equation 2. “At” indicates a weight on time period t.

The above equation 1 corresponds to a case where all weights on the time periods are 1, respectively.

$$\begin{matrix}[ Formula 3 ] & \\ {\sum }_{t = t 1}^{t 2} At * \vert Xt - Yt \vert & Equation 2\end{matrix}$$

The method disclosed in the present embodiment is effective in a case where, for example, a reference user exists and a specific profile is given to a user having a distribution of behavior probabilities identical to as or approximate to that of the reference user.

The present embodiment may be combined with the first embodiment. For example, for the profile candidate “at home in morning and daytime”, whether the selection condition of the first embodiment is satisfied is determined, and for the profile candidate “not at home in morning and daytime”, the similarity level is less or equal to than threshold C as disclosed in the present embodiment.

### Third Embodiment

In the first embodiment, “at home” is used as the specific behavior and “at home profile” is used as the profile which is set on the user. In the present embodiment, “cooking” and “laundry” are added as the specific behavior and also with respect to the profile, “cooking profile” and “laundry profile” are added together with “at home profile”. That is, three profiles are set on the user. According to a set of the three profiles which is set on the user, the offer information for providing to the user is determined. The present embodiment is described based on an extended example of the first embodiment; however, it may be described based on an extended example of the second embodiment in the same way.

Below, the present embodiment is described in detail. The block diagram of the present embodiment is FIG. 1 which is same as that of the first embodiment.

The behavior estimator 33 estimates, for the target user, existence or non-existence of cooking and existence or non-existence of laundry in addition to existence or non-existence of at home.

In order to estimate the existence or non-existence of cooking, the behavior estimator 33 periodically acquires, based on the power consumption data in the power consumption DB 32, kitchen consumed power energy. The kitchen consumed power energy is consumption power energy of a whole kitchen in which cooking appliances (IHcooking appliance, oven, instantaneous water heater, kitchen air fan etc.) are connected in the house.

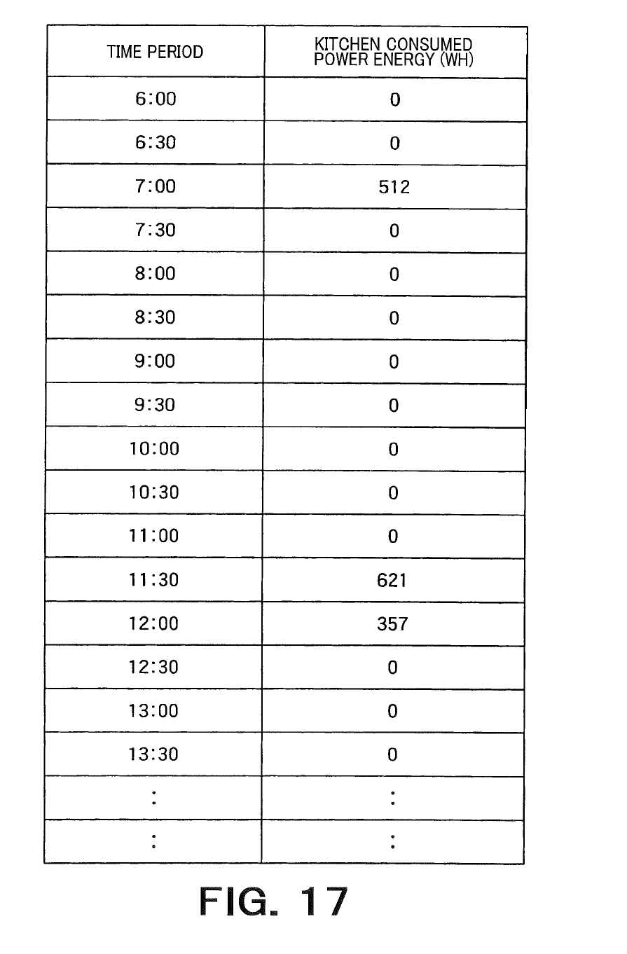

The kitchen consumed power energy can be calculated by acquiring consumption power (instantaneous power) of the whole kitchen from the sub-breaker 12 to which the cooking appliances are connected and integrating the consumption power per constant time. FIG. 17 shows an example of kitchen consumed power energy in each time period at a constant time interval.

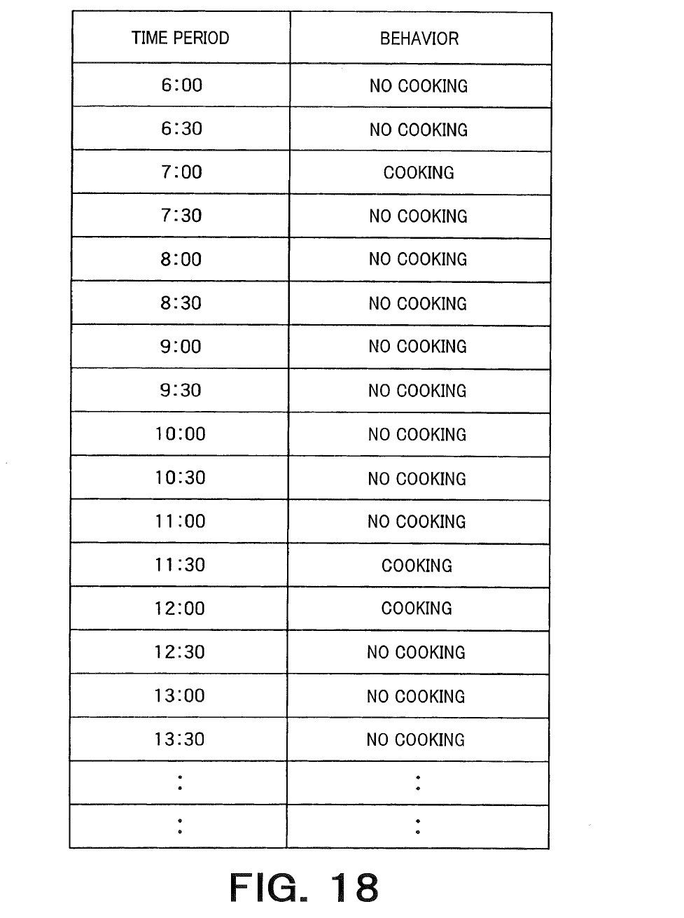

The behavior estimator 33 compares the kitchen consumed power energy of each time period with a predetermined value, and estimates that the cooking is performed when the kitchen consumed power energy is greater than the predetermined value. The behavior estimator 33 estimates that the cooking is not performed when the kitchen consumed power energy is less or equal to than the predetermined value. FIG. 18 illustrates an example of the estimated result on existence or non-existence of the cooking.

Ordinarily, there is no standby electricity on the cooking appliance (if it exists at all, it is extremely small amount and smaller than a threshold of power sensor sensitivity), and therefore, the above predetermined may be set to an extremely small value (e.g., 0). However, if the standby electricity is assumed to be larger than the threshold of the sensor sensitivity, such threshold may be set that a rated standby electricity of the cooking appliance may be reflected. The standby electricity may be a maximum or an average of standby electricity values of various cooking appliances available at a market, or may be obtained by way of questionary investigation to users.

As is the case of the existence or non-existence of the cooking, existence or non-existence of the laundry may be also estimated from power consumption data of the laundry machine. As an estimation example of another behavior, existence or non-existence of TV watching etc. may be estimated from power consumption data of the TV.

The evaluation value calculator 42 calculates, as is the case of the first embodiment, an evaluation value of each time period for each specific behavior: “at home”, “cooking” and “laundry”. The evaluation value of each time period is calculated in the same way as the first embodiment. In the present embodiment, as respective evaluation values, “at home probability”, “cooking probability” and “laundry probability” are calculated. The evaluation value calculator 42 stores the evaluation values calculated for each specific behavior (i.e., at home probability, cooking probability, laundry probability) in the evaluation value storage 46.

In the profile candidate storage 47, for each specific behavior of “at home”, “cooking” and “laundry”, a plurality of profile candidates and a plurality of selection conditions corresponding to the profile candidates.

As examples of the profile candidate and the selection condition for “at home”, as is the case of first embodiment, those in shown FIG. 6 or FIG. 8 can be employed.

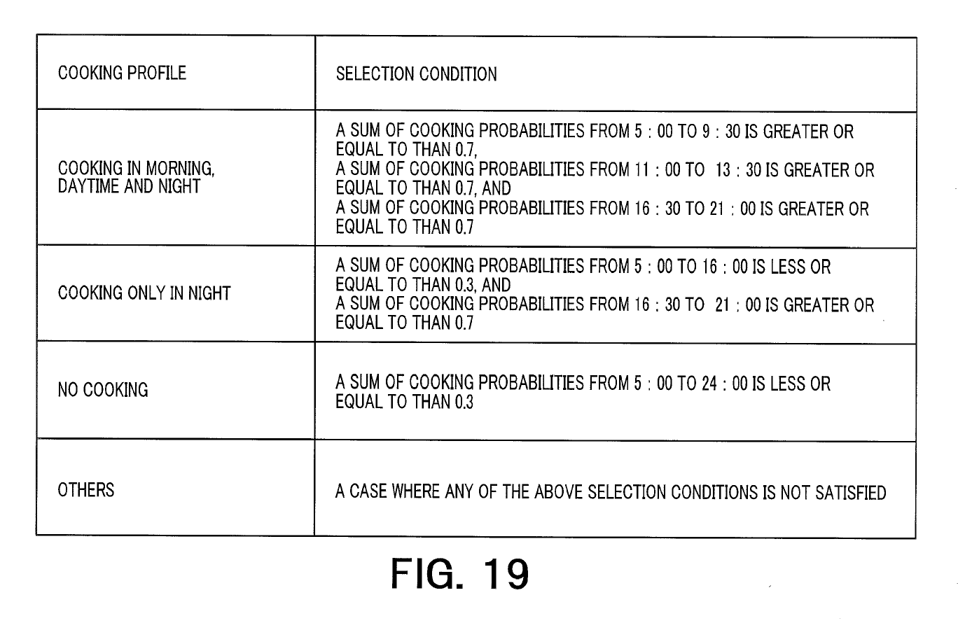

FIG. 19 shows examples of the profile candidate and the selection condition for “cooking”.

In FIG. 19, each selection condition indicates constraint based on a sum of cooking probabilities of time periods included in the specified time span. For example, correspondingly to “cooking in morning, daytime and night”, the selection condition is “a sum of cooking probabilities from 5:00 to 9:30 is greater or equal to than 0.7, a sum of cooking probabilities from 11:00 to 13:30 is greater or equal to than 0.7, and a sum of cooking probabilities from 16:30 to 21:00 is greater or equal to than 0.7”. The time span from 5:00 to 9:30 corresponds to morning, the time span from 11:00 to 13:30 corresponds to daytime, and the time span from 16:30 to 21:00 corresponds to night. With use of a sum of probabilities, even if the time period in which the cooking is performed shifts from day to day at certain degree, whether the cooking is performed in morning, daytime or night can be determined. For example, assumed that there are two users which always cooks one time during a time span from 5:00 to 9:30. One user of the two users cooks at 7:00 and the other user cooks 7:00 or 8:00 at a fifty-fifty probability. In this case, for each user, a sum of cooking probabilities in the time span from 5:00 to 9:30 is calculated as 1.0 and therefore, the users both cook in any time period in morning.

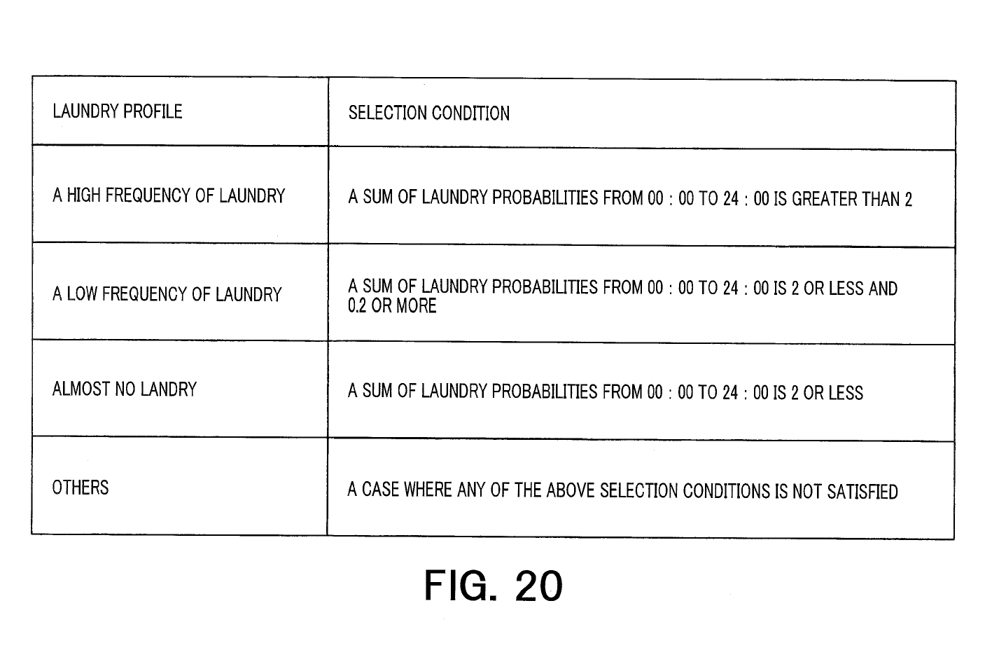

FIG. 20 shows examples of the profile candidate and the selection condition for “laundry”.

In FIG. 20, each selection condition indicates constraint based on a sum of laundry probabilities of time periods included in a whole day (0:00 to 24:00). For example, when the sum of laundry probabilities of time periods included in a whole day is greater than 2.0, the selection condition corresponding to “a high frequency of laundry” is satisfied (in this case, it can be determined that laundry is averagely performed twice in one day).

The detector 39a of the profile setter 43 determines whether the selection condition corresponding to each profile candidate is satisfied based on the evaluation values of time periods for each specific behavior(at home, cooking, and laundry) in target user.

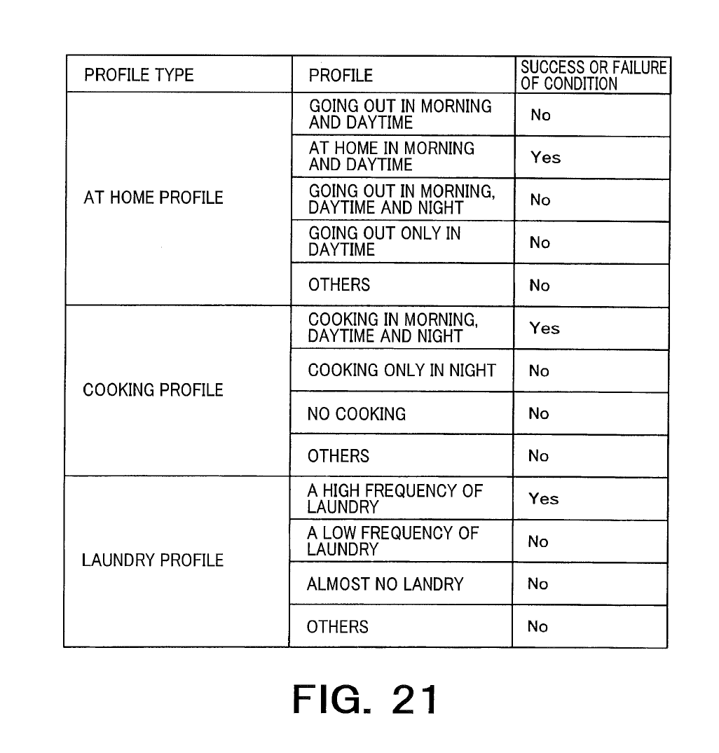

FIG. 21 shows determination results on selection conditions of profile candidates related to each of “at home”, “cooking” and “laundry” with respect to a target user. “Yes” means that the selection condition is satisfied, and “No” means that “selection condition” is not satisfied.

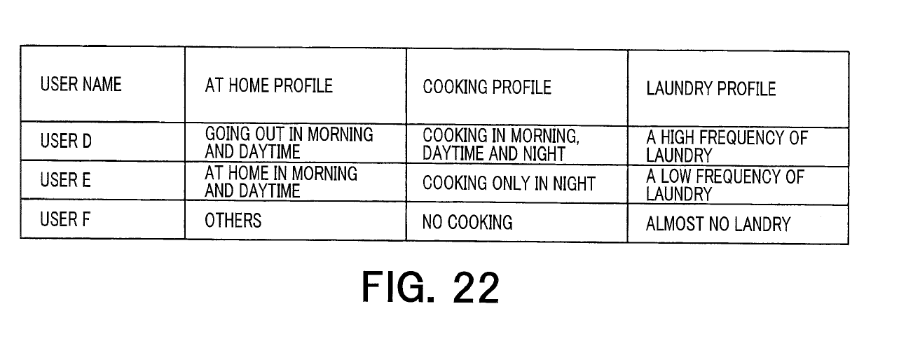

The setter 39b of the profile setter 43 selects, based on the determination results of the selection conditions, the at home profile candidate, the cooking profile candidate and the laundry profile candidate each one from the profile candidate storage 47, and determines each selected candidate as the user's profiles. In the example of FIG. 21, per profile type, one selection condition is satisfied and therefore, the profile candidate is selected each one for which the relevant selection condition is satisfied. If the selection conditions corresponding to the candidates are satisfied, one candidate may be selected as is the case of the first embodiment. FIG. 22 exemplifies the at home profile, the cooking profile and the laundry profile set for user D, user E, user F respectively.

The attribute storage 49 stores an attribute table in which a set of three profiles, a user attribute and an information attribute are associated with each other. Differently from the first embodiment, the user attribute is newly added. The user attribute corresponds to user's household attribute which is supposed from the relevant set of the profiles. By combining a plurality of profiles, the user can be categorized in detail. Thereby, setting of information attribute can finely be made.

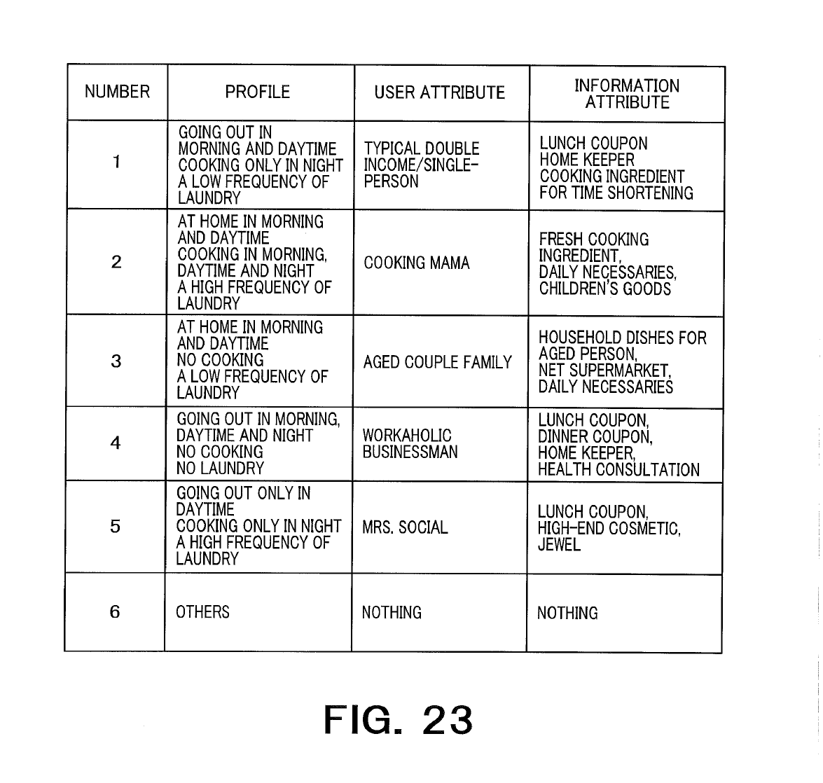

FIG. 23 exemplifies the attribute table stored in the attribute storage 49.

For example, at a row of number 1, the set of profiles “going out in morning and daytime”, “cooking only in night) and “a low frequency of laundry” is set. As the user attribute, “typical double income/single-person” is set. That is, the user which is set to the set of profiles is considered to be typical double income or single-person household, which works in daytime and cooks for itself (self-catering) after coming back home. For the user, it is suitable to provide information relating to a lunch coupon or a home keeper etc. Therefore, as the information attribute, “lunch coupon”, “home keeper” and “cooking ingredient for time shortening” are set.

At a row of number 2, the set of profiles “at home in morning and daytime”, “cooking in morning, daytime and night” and “a high frequency of laundry” are set. As the user attribute, “cooking mama” is set. The user which is set to the set of profiles is considered to be a large household in which a house keeper exists, cooking for the user's own self (self-catering) is done, and there is a lot of washing to do. For the user, it is suitable to provide information relating to cooking ingredient or daily necessaries etc. Therefore, as the information attribute, “fresh cooking ingredient”, “daily necessaries” and “children's goods” are set.

At a row of number 3, the at home profile is “at home in morning and daytime” which is same as the row of number 2 although the cooking profile and the laundry profile are “no cooking” and “a low frequency of laundry”. Accordingly, the user is supposed where retired aged couple lives, no cooking is made (for example, the wife buys household dishes or a boxed lunch outside). Therefore, the user attribute, “aged couple family” is set. For the user, instead of “fresh cooking ingredient”, it is suitable to provide information relating to household dishes for aged person and net-supermarket. As the information attribute, “household dishes for aged person” and “Net supermarket” and “daily necessaries” are set.

At a row of number 4, the set of profiles “going out in morning, daytime and night”, “no-cooking” and “not launder” are set. As the user attribute, “workaholic businessman” is set. The user which is set to the set of profiles is considered to be such a household that a single-person lives, prefers dining out and has high income. For the user, it is suitable to provide information relating to a coupon of lunch or dinner, a home keeper, health etc. Therefore, as the information attribute, “lunch coupon”, “dinner coupon”, “home keeper” and “health consultation” are set.

At a row of number 5, “going out only in daytime”, “cooking only in night”, “a high frequency of laundry” are set. As the user attribute, “Mrs. Social” is set. The user which is set to the set of profiles is considered to be such a household that a house keeper lives, there is tendency of dining out for lunch, a family is social and household income is high. For the user, it is suitable to provide information relating to a lunch coupon or a luxury item. Therefore, as the information attribute, “lunch coupon” and “high-end cosmetic” and “jewel” are set.

As stated above, by combining a plurality of profile types, the user attribute (the user's household attribute) can be defined and more appropriate information attribute can be thus set. For example, in the rows of numbers 2 and 3, “at home profile” is both “not at home in morning and daytime” and therefore, in the case of the first embodiment, it is difficult to distinguish the user for the cases corresponding to the rows of number 2 and 3. In contrast, in the present embodiment, by using the plurality of types of profile, even in the cases corresponding to the rows of number 2 and 3, the user can be distinct for each case and thereby, the information can be finely provided to the user.

The attribute setter 44 acquires the set of profiles which is set on the target user from the profile setting storage 48 and, based on the acquired set of profiles, specifies the relevant user attribute and relevant information attribute in the attribute table of the attribute storage 49 to set the specified those on the target user. Specifically, the attribute setter 44 specifies a row in the attribute table with which all of three profiles in the set of profiles on the target user match, and sets the user attribute and the information attribute in that row on the target user. The attribute setter 44 stores the user attribute and the information attribute, which are set on target user, in the attribute setting table of the attribute setting storage 50 together with the set of profiles.

For example, in FIG. 22, the set of profiles on the user D matches the set of profiles at the row of number 2 in FIG. 23. Therefore, for the user D, the user attribute and the information attribute at the row of number 2 is set. Also, the set of profiles on the user E matches the set of profiles at the row of number 1. Therefore, for the user E, the user attribute and the information attribute at the row of number 1 are set.

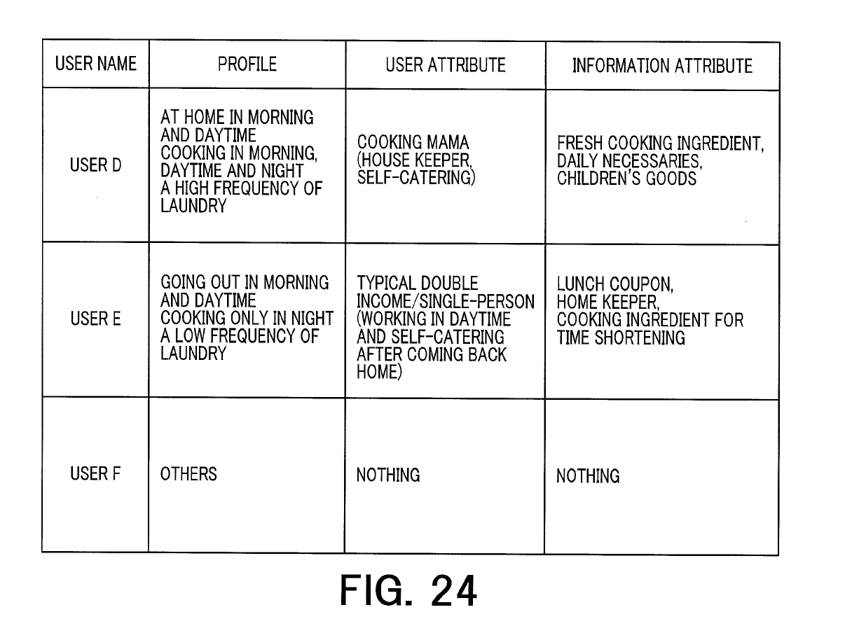

FIG. 24 shows an example of the attribute setting table of the attribute setting storage 50. The user attribute and the information attribute set for each of users D, E and F are stored together with the relevant set of profiles.

The information transmission processing unit 45 uses the user attribute and the information attribute which is set on the target user and determines offer information to be provided to the target user. The information transmission processing unit 45 transmits the offer information to the target user.

Specifically, as is the case of the first embodiment, the information transmission processing unit 45 reads out, based on the information attribute, the offer information to be provided to the target user from the offer information storage 37. Then, the information transmission processing unit 45 uses the user attribute and changes a format of the offer information to be transmitted. For example, when the user attribute is “aged couple”, the unit 45 changes the setting of the character font size in the offer information so as to become larger than a normal size.

The utilization of the user attribute is not limited to the change of the font size. For example, the user attribute may be used to determine a time point at which information is transmitted. Alternatively, the user attribute may be used to determine a maximum number of pieces of offer information. For example, in the case of “cooking mama”, assumed that the user is a family which would like to buy by collecting more information, the maximum number of pieces of offer information to transmit is made higher. Also, in the case of “aged couple family”, assumed that they feel cumbersome if the number of pieces of the offer information is much, the maximum number of pieces of offer information to transmit is made lower.

The use of the user attribute is not essential and the offer information to be provided may be determined with use of only the information attribute.

As stated above, according to the present embodiment, the set of profiles is set on the user and thereby, information can be finely provided to the user.

### Fourth Embodiment

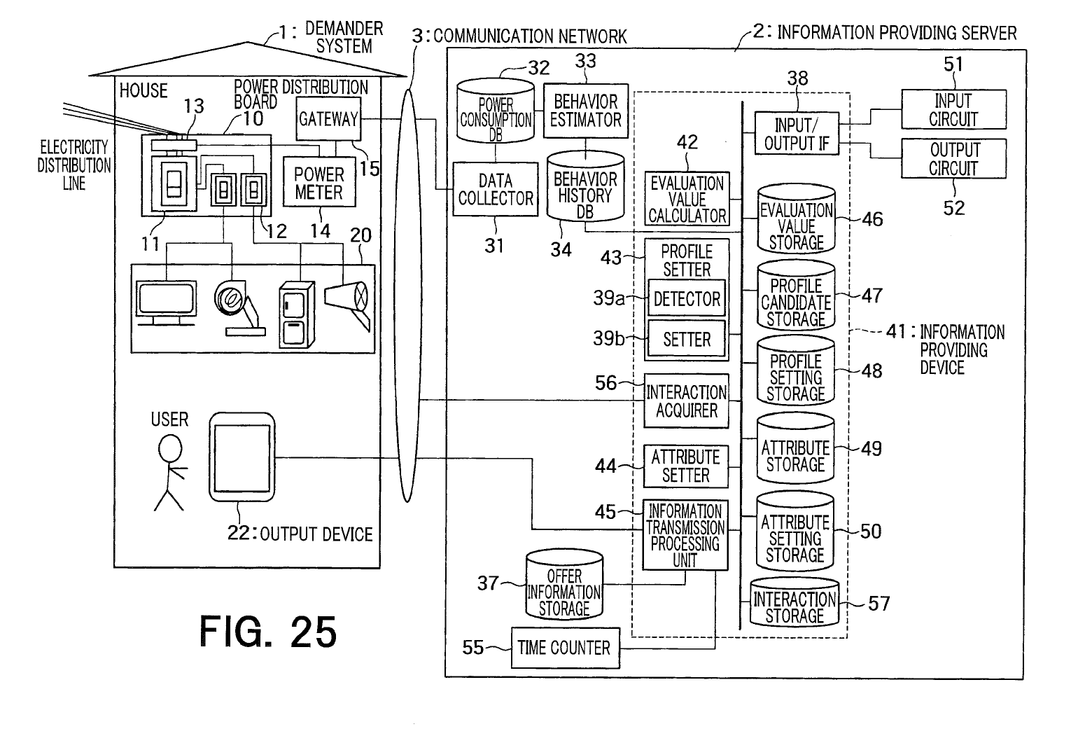

FIG. 25 is a block diagram of an information providing system according to a fourth embodiment.

In the present embodiment, a time counter 55 and an interaction acquirer 56 are additionally arranged in the information providing server 2. The interaction acquirer 56 is connected to the bus in the information providing device 41. The time counter 55 is connected to the information transmission processing unit 45. The behavior history DB is connected to the bus in the information providing device 41.

The time counter counts a time and notifies a current time to the information transmission processing unit 45 according to a request from the information transmission processing unit 45.

The interaction acquirer 56 communicates with the output device 22 possessed by the user via the communication network 3. The interaction acquirer 56 acquires interaction information which is operation information given to output device 22 by the user, the user being provided with offer information. The interaction acquirer 56 may be connected to the communication network 3 at the same communication interface as that used by the information transmission processing unit 45 or the data collector 31, or communicate at a difference communication interface from that used by the information transmission processing unit 45 or the data collector 31.

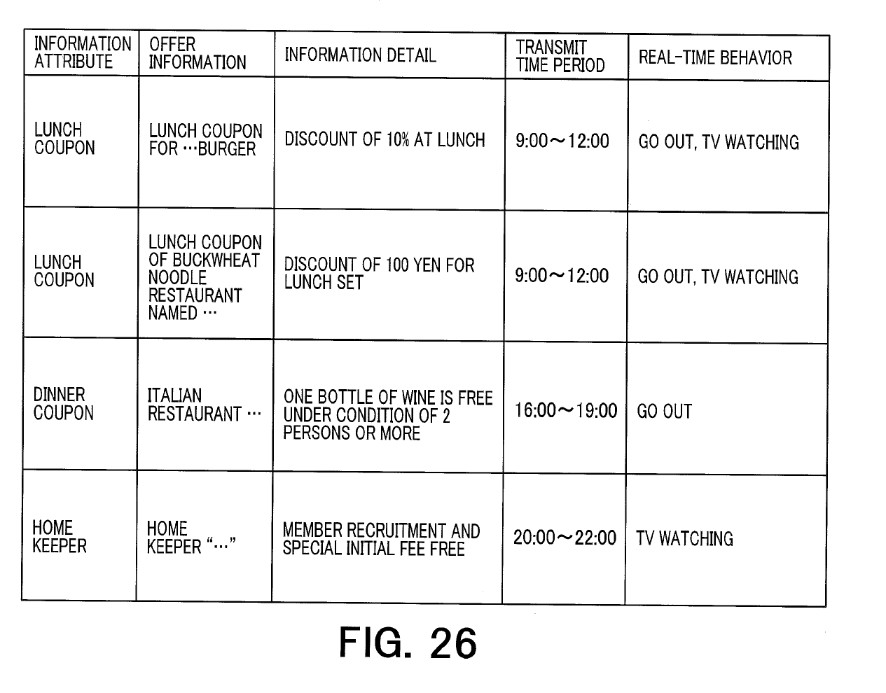

FIG. 26 shows an information table in the offer information storage 37.

The information table is extended from that of the first embodiment to add columns “transmit time period” and “real-time behavior”.

The “transmit time period” defines a condition on a time period in which the relevant offer information can be provided to the user.

The “real-time behavior” defines a condition on a current behavior imposed on the use to provide the relevant offer information to the user. In a case where a plurality of behaviors are set in the real-time behavior column, it is sufficient to satisfy any one of the behaviors.

When both conditions of the transmit time period and the real-time behavior are satisfied, the offer information is allowed to be provided to the user.

The information transmission processing unit 45 acquires, based on the profile of the user in the profile setting storage 48, from the information attribute table in the attribute storage 49, the relevant information attribute. Assumed that “lunch coupon” and “home keeper” are acquired (refer to user A in FIG. 12).

The information transmission processing unit 45 accesses the offer information storage 37 and detects, in the information table in FIG. 26, rows of “lunch coupon” and “home keeper”. Two rows of “lunch coupon” and one row of “home keeper” are detected.

The information transmission processing unit 45 acquires, from the time counter 55, the current time. Also, the information transmission processing unit 45 acquires, from the behavior history DB 34, the current behavior of the user. The current behavior is a latest behavior of the user recorded in the behavior history DB 34. When the behavior of the user is updated at a time interval of 30 minutes, the latest behavior is a behavior taken within 30 minutes right before now at most.

The information transmission processing unit 45 checks whether the current time and the current user behavior satisfy conditions on the transmit time period and the real-time behavior in the rows specified in the information table. With respect to the row(s) for which the both conditions are satisfied, the information transmission processing unit 45 acquires the offer information corresponding to the row(s) from the information table and transmits the acquired offer information to the output device 22 of the user.

For example, when the current behavior is “go out” and the current time is 11:00, the both conditions are satisfied on each of two rows of “lunch coupon”. Specifically, since the transmit time period is “9:00 to 12:00”, the current time 11:00 satisfies the condition on the transmit time period. Also, since the real-time behavior is “go out” or “TV watching” and the user's current behavior is “go out”, the real-time behavior of “go out” is matched and thus the condition of the real-time behavior is satisfied. Two offer information of “lunch coupon of . . . burger” and “lunch coupon of buckwheat noodle restaurant named . . . ” are acquired from the information table and transmitted to the output device 22 of the user. On the other hand, since the transmit time period is “20:00 to 22:00” in the row “home keeper” and the current time is 11:00, the condition of the transmit time period is not satisfied. Therefore, the offer information of “member recruitment and special initial fee free” is not transmitted to the output device 22 of the user.

The information transmission processing unit 45 can carry out a transmission routine, which includes acquisition of the information attribute based on the profile of the user, condition determination based on the information table and transmission of the offer information as described above, at an arbitrary timing. For example, the transmission routine may be carried out at a time interval of a unit time (e.g., one second, two hours or the like)

Alternatively, the transmission routine may be carried out at the following timing. For example, the behavior estimator 33 estimates existence or non-existence of a certain behavior of the user and stores the estimated result in the behavior history DB. The information transmission processing unit 45 checks, based on the behavior history DB, whether the certain behavior is being performed behavior, and when the certain behavior is determined as being performed, the information transmission processing unit 45 carries out the transmission routine. The behavior estimation may be periodically performed and along with this, based on the behavior history DB, the existence or non-existence of the certain behavior of the user may be checked. As an example of the behavior estimation on the user, whether the user is operating the output device (e.g., PC) may be estimated. The estimation of whether the output device is being operated may be performed by acquiring an operation history of the PC as described in a sixth embodiment later.

The above transmission routine can be also performed with use of both of the above two methods.

The interaction acquirer 56 acquires, after the information transmission processing unit 45 transmits information to the output device 22, an operation (e.g., click) taken on the output device 22 by the user, as interaction information. For example, in order to notify a click event to the interaction acquirer 56 in a case where the user clicks a lunch coupon displayed on the output device 22 to use the coupon, an instruction is set in data of the offer information transmitted to the output device 22. Thereby, the interaction acquirer 56 acquires the user's interaction information.

The interaction acquirer 56 stores the acquired interaction information in the interaction storage 57. On this occasion, the interaction information may be stored for each of the profiles set on the user. The interaction acquirer 56 processes the interaction information in the interaction storage 57 according to an instruction given by the operator of the input circuit 51 and the output circuit 52, and displays the processed data on the output circuit 52. For example, the output circuit 52 displays statistics information obtained by operating statistical processing on the interaction information for each profile. Alternatively, the output circuit 52 may display a list of pieces of the interaction information in the interaction storage 57 on the output circuit 52.

The operator of the output circuit 52 watches the statistics information etc. and can check whether contents of the profile candidate table, the attribute table and the information table etc. are appropriate. As an example of the statistics information, there is a distribution which represents existence or non-existence of coupon clicks on profiles.

When the operator determines that any of the tables is necessary to be changed, the operator may use the input circuit 51 to update the relevant table. For example, the condition on the transmit time period or the condition on the real-time behavior in the information table may be changed. A new offer information may be added in the information table or the offer information in the information table may be replaced with another offer information. By rewriting the profile candidate table or the attribute table, operations on profile setting or attribute setting can be also adjusted.

As stated above, according to the present embodiment, information depending on the user's current behavior or the current time can be provided. Also, the interaction information which is feedback of the user for the provided information is acquired, an each table is updated as necessary, resulting that providing of information which is more appropriate to the user can be realized.

### Fifth Embodiment

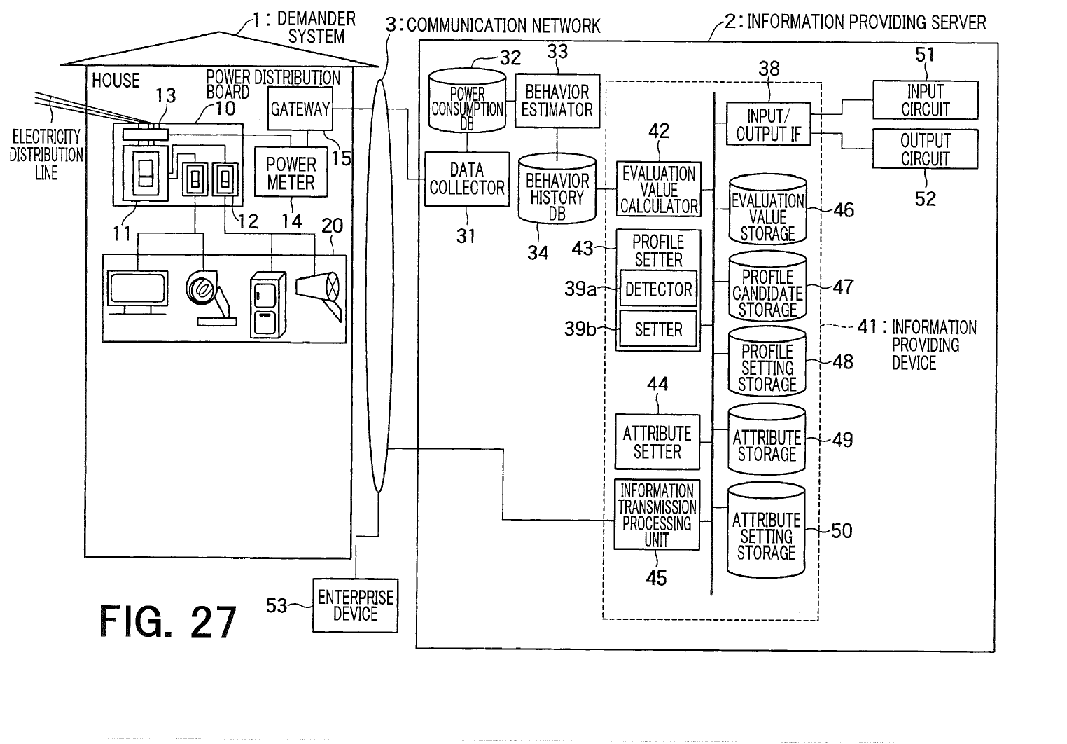

FIG. 27 shows an information providing system according to the fifth embodiment. Differently from FIG. 1, the enterprise device 53 is connected to the communication network 3. The output device is removed from the demander and the offer information storage is removed from the information providing server 2. Operations of the present embodiment may be combined with any of first to fourth embodiments. On this occasion, the output device and the offer information storage may exist.

In the present embodiment, the information transmission processing unit 45 generates information to be provided to the enterprise with use of the profile setting storage 48, the attribute setting storage 50 or both of them, and transmits the generated information to the enterprise device 53.

The information to be provided to the enterprise may be data itself stored in the profile setting storage 48, the attribute setting storage 50 or both of them.

Alternatively, statistics information obtained by operating statistical processing on the data may be provided to the enterprise. This can be carried out even in a case wherein it is difficult to provide the data itself due to a privacy contract etc. As an example of the statistics information, there may be information of how many users having what profile or what user attribute exist.

As stated above, according to the present embodiment, information based on the profile set on each user is provided to the enterprise. The enterprise can utilize the information based on the profile in the context of marketing to product information or services truly needed by users.

### Sixth Embodiment

In the first to fifth embodiments, the behavior estimation on the user is performed based on the power consumption data.

In the present embodiment, sensor information or an operation history is acquired from user's appliances and based on the acquired information or history, the behavior estimation is performed.

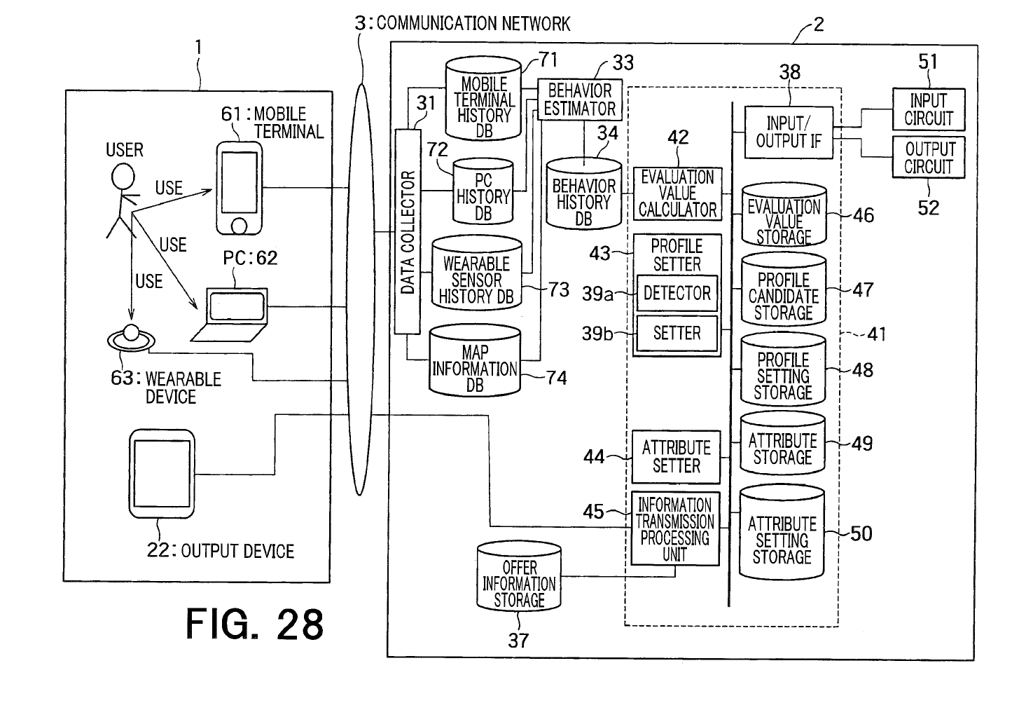

FIG. 28 is a block diagram of an information providing system according to the present embodiment. The configuration of the demander system is substantially differently from that of the first embodiment. The power distribution board, the power meter, the gateway and the like, which are illustrated in FIG. 1, are not arranged. In the demander's house, at least one of a mobile terminal 61, a personal computer (PC) 62 and a wearable device 63 is arranged. The user uses at least one of the mobile terminal 61, the personal computer (PC) 62 and the wearable device 63. The output device 22 may be the mobile terminal 61, the PC 62 or another device other than these.

In the information providing server 2, the power consumption DB is not arranged, a mobile terminal history DB 71, a PC history DB 72, a wearable sensor history DB73, a map information DB 74 are additionally arranged. The DBs are connected to the data collector 31 and the behavior estimator 53.

The mobile terminal 61 is a terminal such as a smart phone or a mobile phone, and a sensor such a GPS sensor or an acceleration sensor is mounted therein. The mobile terminal 61 is connectable wiredly or wirelessly to the communication network 3. In the mobile terminal 61, software such as a Web browser or mailer is installed. On this case, the user can connect to the Internet by means of the mobile terminal 61 and carry out Web surfing or video viewing etc. The communication network 3 may be a part of the Internet.

The PC 62 is a PC in which the Web browser, the mailer or the like is installed. The PC62 can be connected to the communication network 3 wiredly or wirelessly. The user can connect to the Internet by means of the PC 62 and carry out Web surfing or video viewing etc.

The wearable device 63 is a device which the user can wear on its body (wrist etc.) and a biological sensor such as a pulse wave sensor or a blood pressure sensor is mounted therein. Also, in the wearable device 63, a GPS sensor or an acceleration sensor etc. may be mounted. The wearable device 63 can be connected to the communication network 3 wiredly or wirelessly.

The data collector 31 in the information providing server2 collect the corresponding information from the mobile terminal 61, the PC 62 or the wearable device 63 and stores the information in the mobile terminal history DB 71, the PC history 72 or the wearable sensor history DB73.

Specifically, the data collector 31 collects, from the mobile terminal 61, a history of sensor information such as the GPS sensor or acceleration sensor and stores the history of sensor information collected, in the mobile terminal history DB71. In the sensor information, for example, sensing values, a user ID and sensing times are included. When the sensing times are not included, times at which the sensor information is collected by the data collector 31 may be added to the sensor information. The collecting may be carried out by transmitting a request at a constant time interval to the mobile terminal 61. When there is no response from the mobile terminal 61 due to power off etc., the transmission of the request may be stopped during a constant time period. Alternatively, the mobile terminal may autonomously periodically transmit the history of the sensor information to the data collector 31. Alternatively, the mobile terminal 61 may transmit the history of the sensor information to the data collector 31 at a time of start-up or shutting down.

The data collector 31 collects, from the PC 62, the operation history information on the PC, and stores the information in the PC history DB 72. For example, in the PC 62, a history or the like such as accessed URIs, on/off of power or starting up/ending of an application are stored, the data collector 31 collects the history as the operation history. The collecting may be carried out by transmitting a request at a constant time interval to the PC 62. When there is no response from the PC 62 due to power off etc., the transmission of the request may be stopped during a constant time period. Alternatively, the PC 62 may autonomously periodically transmit the history of the sensor information to the data collector 31. Alternatively, the PC 62 may transmit the history of the sensor information to the data collector 31 at the time of start-up or shutting down.

The data collector 31 collects, from the wearable device 63, sensor information such as a pulse wave sensor or a blood pressure sensor and stores the sensor information in the wearable sensor history DB 73. In the sensor information, for example, sensing values, a user ID and sensing times are included. When the sensing times are not included, times at which the sensor information is collected by the data collector 31 may be added to the sensor information.

The map information DB 74 stores latitude and longitude information of the GPS, a type of facility placed at a position indicated by the latitude and the longitude, and a related behavior at the facility. As the type of facility, for example, there are “gym”, “tennis court”, “hot spring” and “Japanese-style bar”. The related behavior is a behavior which may be taken in the facility; “exercise (at gym)”, “exercise (at tennis court)”, “relaxing (at hot spring)” and “drinking (at Japanese-style bar)”.

The behavior estimator 33 performs behavior estimation on the user based on the DBs.

Below, as the estimation performed by the behavior estimator 33, an example is shown which estimate existence or non-existence of each behavior: “device use”, “exercise”, “heavy feeling of drowsiness”. Other than these behaviors, it is possible estimate any behavior as long as it can be estimated by the above each DB.

### [Device Use]

The device use means use of the mobile terminal 61 or the PC 62. The behavior estimator 33 estimates, for the mobile terminal or the PC, existence or non-existence of “PC use” or “smart phone use”. For example, the behavior estimator 33 performs behavior estimation at a constant time interval. When an event such as a Web access or on/off of power occurs in the PC within the time period, the behavior estimator 33 may determine the existence of “PC use”. When the event does not occur, the behavior estimator 33 may determine non-existence of “PC use”. The behavior estimator 33 sets a behavior label indicating a result of the estimation on the time period. Also, when possible, the behavior estimator 33 may estimate, in more detail, a behavior such as “Web surfing”, “video viewing”, “mail” or “chat” behavior.

### [Exercise]

The exercise means that the user takes a motion having a size above a certain level. In order to estimate existence or non-existence of exercise, a sensor value of the GPS sensor or the acceleration sensor in the mobile terminal 61 is used.

As an example of using the GPS sensor value, the related behavior taken in the facility placed at the position shown by GPS sensor value is detected in the map information DB 74 and whether the related behavior is “exercise” is checked. If it is “exercise”, the user is determined to exercise in that facility, resulting in that an “exercise” label is allocated to the relevant time period. If it is not “exercise”, “no exercise” label is allocated to the relevant time period.

As an example of using the acceleration sensor value, when the acceleration sensor value is greater than a predetermined threshold, the user is determined to exercise and an “exercise” label is allocated to the relevant time period. When the acceleration sensor value is less or equal to than the threshold, the user is determined not to exercise and “no exercise” label is allocated to the relevant time period.

In the above described example, existence or non-existence of the exercise is estimated although strength of the exercise may be targeted. For example, by distinguishing the strength of the exercise, three levels “light exercise”, “heavy exercise” and “no exercise” may be provided.

### [Heavy Feeling of Drowsiness]

The heavy feeling of drowsiness means that the user feels very drowsy (sleepy). In order to estimate whether the user's feeling of drowsiness is heavy, as one example, a pulse wave sensor mounted in the wearable device 63 can be utilized. For example, a pattern of pulse wave sensor values at a time of heavy feeling of drowsiness is previously registered, and when the pulse wave sensor values of the user is close to the previously registered pattern, the user is estimated to have heavy feeling of drowsiness and a behavior label “Heavy feeling of drowsiness” is thus allocated. For the above estimation, any known method may be used.

Below, based on the above stated behavior “device use”, “exercise” or “heavy feeling of drowsiness” behavior, an example is described which determines offer information for providing to the user (here, healthcare related information).

The “device use” (use of a PC or a mobile terminal) is involved closely in human life of today and possibly disturbs sleep. Based on this, for example, a behavior probability of “device use” is greater or equal to than 0.8 for each time period in a time span from 22:00 to 24:00, a profile “device use in the middle of night” is set and information attribute of “method for relaxing in the middle of night” is set. In this case, it is considered to provide information on a book or a seminar etc. related to a method for relaxing in the middle of night to the user as the offer information.

As for the “exercise”, by detecting a behavior probability in each of morning, daytime and night, providing of information related to healthcare becomes possible. For example, it is known that there is a possibility that jogging immediately after a human gets up early in morning but not daytime or night causes feeling unwell due to sudden exercise load. Based on this, for example, when a sum of behavior probabilities of “exercise” in a time span from 5:00 to 7:00 is greater or equal to than 0.8, a profile “exercise early in morning” is set to the user and information attribute of “health advice” is set. In this case, it is considered to provide advice information on health to the user as the offer information.

As for the “heavy feeling of drowsiness”, it is generally said that there is a possibility of disorder of sleep if the behavior of the heavy feeling of drowsiness occurs at a high frequency in daytime. Based on this, for example, when a sum of behavior probabilities of “heavy feeling of drowsiness” in a time span from 15:00 to 17:00 is greater or equal to than 0.8, a profile “heavy feeling of drowsiness in daytime” is set to the user and information attribute of “goods for pleasant sleep” is set. In this case, it is considered to provide information on goods for pleasant sleep and a book relevant thereto to the user as the offer information.

As stated above, according to the present embodiment, by detecting the user's situation based on the operation history of the mobile terminal or PC, the information of the sensor mounted in the mobile terminal and the information mounted in the wearable device, the user's behavior can be estimate in more detail.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information providing device comprising a computer including at least one processor, comprising;
an evaluation value calculator implemented by the computer to configured calculate an evaluation value on each of a plurality of time periods based on behavior history data which indicates a history of days and times of occurrence of a specific behavior taken by a user, the evaluation value indicating likelihood of the specific behavior being taken by the user;
a profile setter implemented by the computer configured to set a profile on the user based on the evaluation values of the time periods, the profile indicating a tendency of time periods at which the specific behavior is taken by the user; and
an information transmission processing unit implemented by the computer configured to determine offer information for providing to the user according to the profile of the user and transmit the offer information to an output device related to the user.

2. The information providing device according to claim 1, the profile setter comprising:
a detector implemented by the computer configured to use profile candidate data which associates a plurality of profile candidates each indicating tendency of time periods at which the specific behavior is taken and a plurality of selection condition each defining constraint based on evaluation values of the time periods, and detect the profile candidate corresponding to the selection condition which the evaluation values of the time periods calculated by the evaluation value calculator satisfy from among the selection conditions; and
a setter implemented by the computer configured to set a detected profile candidate on the user as the profile.

3. The information providing device according to claim 2, wherein
the selection condition requests that the evaluation of one or more specified time period is greater or equal to than a threshold, or less or equal to than the threshold.

4. The information providing device according to claim 2, wherein
the selection condition requests that an average of the evaluations of one or more specified time periods is greater or equal to than a threshold, or less or equal to than the threshold.

5. The information providing device according to claim 2, wherein
the selection condition requests that a number of time periods, among one or more specified time periods, at which the evaluation values is greater or equal to than a threshold or less or equal to than the threshold, is greater or equal to than a predetermined value, or less or equal to than the predetermined value.

6. The information providing device according to claim 2, wherein
the selection condition requests that the evaluation values increase or decrease over a plurality of specified time periods.

7. The information providing device according to claim 2, wherein
the profile setter selects, when two or more of the selection conditions are satisfied, a predetermined number of profile candidates out of the profile candidates corresponding to the two or more of the selection conditions, and sets selected profile candidates on the user as the profile.

8. The information providing device according to claim 7, wherein the profile setter selects the predetermined number of profile candidates according to priorities given to the profile candidates.

9. The information providing device according to claim 1, wherein the profile setter uses profile candidate data which associates a plurality of reference data each indicating reference values of the time periods and a plurality of profile candidates each indicating tendency of time periods at which the specific behavior is taken, similarity levels based on differences between the evaluation values and the reference values of the time periods calculated by the evaluation value calculator, specifies one of the plurality of reference data according the similarity levels, and sets the profile candidate corresponding to the specified reference data on the user as the profile.

10. The information providing device according to claim 2, wherein
the information transmission processing unit uses attribute data which defines at least one information attribute for each of a plurality of profiles, specifies the information attribute corresponding to the profile of the user, and determines the offer information for providing to the user based on the specified information attribute.

11. The information providing device according to claim 10, wherein
the information transmission processing unit acquires data indicating a latest behavior of the user estimated by a behavior estimation device which estimates a behavior of the user, and determines the offer information for providing to the user the latest behavior of the user.

12. The information providing device according to claim 11, wherein
the information transmission processing unit acquires a current time from a time counter counting a time and determines the offer information for providing to the user according to the current time acquired.

13. The information providing device according to claim 1, wherein
the evaluation value calculator calculates the evaluation value on each time period for each of a plurality of specific behaviors,
the profile setter sets the profile on the user for each of the specific behaviors, and
the information transmission processing unit determines the offer information for providing to the user according to a set of the profiles set to the user.

14. The information providing device according to claim 13, wherein
the profile setter determines a format of the offer information for providing to the user according to the set of the profiles set to the user, and transmits the offer information in the format to the output device.

15. The information providing device according to claim 1, wherein
the evaluation value calculator calculates the evaluation value on each time period based on a number of days in which the user took the specific behavior in each time period.

16. The information providing device according to claim 15, wherein the evaluation value calculator calculates the evaluation value on each time period based on a ratio between a number of days in the behavior history data from which the evaluation value is calculated and a number of days in which the user took the specific behavior in each time period.

17. The information providing device according to claim 1, further comprising:
an interaction acquirer implemented by the computer to communicate with the output device related to the user and acquire interaction information which is operation information taken by the user which has received the offer information via the output device; and
a hardware storage to store the interaction information acquired by the interaction acquirer to be associated with the profile,
wherein the interaction acquirer carries out statistical processing on interactions associated with a plurality of the profiles in the hardware storage to generate statistics information.

18. An information providing device comprising a computer including at least one processor, comprising;
an evaluation value calculator implemented by the computer to configured calculate an evaluation value on each of a plurality of time periods based on behavior history data which indicates a history of days and times of occurrence of a specific behavior taken by a user, the evaluation value indicating likelihood of the specific behavior being taken by the user;
a profile setter implemented by the computer configured to set a profile on the user based on the evaluation values of the time periods, the profile indicating a tendency of time periods at which the specific behavior is taken by the user;
a hardware storage to store a plurality of profiles set on a plurality of users by the profile setter;
an information transmission processing unit implemented by the computer configured to transmit the profiles or information depending on the profiles via a network to a predetermined device.

19. An information providing method performed by a computer including at least one processor, comprising;
calculating an evaluation value on each of a plurality of time periods based on behavior history data which indicates a history of days and times of occurrence of a specific behavior taken by a user, the evaluation value indicating likelihood of the specific behavior being taken by the user;
setting a profile on the user based on the evaluation values of the time periods, the profile indicating a tendency of time periods at which the specific behavior is taken by the user; and
determining offer information for providing to the user according to the profile of the user and transmit the offer information to an output device related to the user.

20. A non-transitory computer readable medium having instructions stored therein which when executed by a computer, causes the computer to perform processes comprising:
calculating an evaluation value on each of a plurality of time periods based on behavior history data which indicates a history of days and times of occurrence of a specific behavior taken by a user, the evaluation value indicating likelihood of the specific behavior being taken by the user;
setting a profile on the user based on the evaluation values of the time periods, the profile indicating a tendency of time periods at which the specific behavior is taken by the user; and
determining offer information for providing to the user according to the profile of the user and transmit the offer information to an output device related to the user.
